(19) United States
(12) Patent Application Publication
(10) Pub. No.: US 2003/0079008 A1
(43) Pub. Date: Apr. 24, 2003

(54) Content distribution system, content reserved-time-extension control apparatus, content reserved-time-extension control method, content reserved-time-extension control program, and content reserved-time-extension control program storage medium

(75) Inventors: Katsushi Fujii, Chiba (JP); Shigehiko Nishizawa, Kanagawa (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: Sony Corporation, Tokyo (JP)

(21) Appl. No.: 10/207,977

(22) Filed: Jul. 31, 2002

(30) Foreign Application Priority Data
Jul. 31, 2001 (JP) 2001-232944

(51) Int. Cl. G06F 17/60; G06F 15/173

(52) U.S. Cl. 709/223

(57) ABSTRACT

A user PC sends an extension request for extending a time slot to a server-use reservation management center while distributing content to client PCs via a streaming server in a distribution channel and in the time slot. The server-use reservation management center sends a new reservation setting information file in which an extended time is set in response to the extension request to the user PC, and also sends extension information to the streaming server. Accordingly, the user PC is allowed to continue to send the content to the streaming server based on the new reservation setting information file, and the streaming server is allowed to continue to distribute the content. Thus, even when it is desired that the time slot be extended while the distribution is being performed, the content can be continuously distributed without suspending the distribution or making a new reservation.

### BACKGROUND OF THE INVENTION

1. Field of the Invention

The present invention generally relates to a content distribution system, a content reserved-time-extension control apparatus, a content reserved-time-extension control method, a content reserved-time-extension control program, and a storage medium in which the content reserved-time-extension control program is stored. The invention can be suitably applied to, for example, a computer network system for distributing content from a user personal computer (PC) to a client via a predetermined streaming server.

2. Description of the Related Art

Hitherto, in a computer network system, when, for example, providing content created by a user via the Internet, the user generally opens a homepage.

When opening a homepage, the user obtains a homepage creation program via a user PC, produces a homepage hyperlinked to a plurality of items of content based on the homepage creation program, and stores the homepage in a streaming server of an Internet service provider (hereinafter referred to as an “ISP”).

The ISP then provides via the streaming server the homepage to a client who has accessed via the Internet, and when an anchor on the homepage is clicked, the ISP provides the content linked to the anchor to the client.

Nowadays, in the streaming server, the content uploaded from user PCs includes not only still images, but also moving pictures and sound, and in response to a request from a client, content of moving pictures, for example, live content, is distributed to the client via the Internet, thereby implementing live distribution.

In this type of computer network system, in order to distribute live content in real time, the user has to reserve a scheduled time slot in advance, and is able to distribute the live content from the user PC to unspecified clients via the streaming server only within the reserved time slot.

Accordingly, in the above-described computer network system, if the user wishes to extend the reserved time slot while the content is being distributed, he/she has to suspend the content distribution to make a new reservation. It is thus difficult to continuously distribute the content without the need to suspend the distribution for making a new reservation.

### SUMMARY OF THE INVENTION

Accordingly, in view of the above-described problem, it is an object of the present invention to provide a content distribution system, a content reserved-time-extension control apparatus, a content reserved-time-extension control method, a content reserved-time-extension control program, and a storage medium in which the content reserved-time-extension control program is stored, in which a reserved time slot can be extended while the content is being distributed without the need to suspend the distribution.

In order to achieve the above object, according to one aspect of the present invention, there is provided a content distribution system including: a user terminal; a content distribution server for distributing content received from the user terminal to a client via a network; and a reservation management server for receiving a reservation for a distribution channel and a time slot in which the distribution channel is to be used from the user terminal. The user terminal makes an extension request for extending the time slot while the content is being distributed to the client via the content distribution server in the distribution channel and in the time slot. The reservation management server sends new reservation setting information in which the time slot is extended in response to the extension request to the user terminal and to the content distribution server, thereby allowing the user terminal to continue to send the content to the content distribution server based on the new reservation setting information, and also allowing the content distribution server to continue to distribute the content.

According to another aspect of the present invention, there is provided a content reserved-time-extension control apparatus for receiving a reservation for a distribution channel and a time slot in which the distribution channel is to be used from a user terminal when content received from the user terminal is distributed from a content distribution server to a client via a network, and for managing the received reservation. The content reserved-time-extension control apparatus includes: an extension request receiver for receiving an extension request for extending the time slot while the content is being distributed from the user terminal to the client via the content distribution server in the distribution channel and in the time slot; a reservation setting information generator for generating new reservation setting information in which the time slot is extended in response to the extension request; and a controller for sending the new reservation setting information to the user terminal and to the content distribution server so as to allow the user terminal to continue to send the content to the content distribution server based on the new reservation setting information, and to allow the content distribution server to continue to distribute the content.

According to still another aspect of the present invention, there is provided a content reserved-time-extension control method for receiving a reservation for a distribution channel and a time slot in which the distribution channel is to be used from a user terminal when content received from the user terminal is distributed from a content distribution server to a client via a network, and for managing the received reservation. The content reserved-time-extension control method includes: an extension request receiving step of receiving an extension request for extending the time slot while the content is being distributed from the user terminal to the client via the content distribution server in the distribution channel and in the time slot; a reservation setting information generating step of generating new reservation setting information in which the time slot is extended in response to the extension request; and a control step of sending the new reservation setting information to the user terminal and to the content distribution server so as to allow the user terminal to continue to send the content to the content distribution server based on the new reservation setting information, and to allow the content distribution server to continue to distribute the content.

According to a further aspect of the present invention, there is provided a content reserved-time-extension control program for allowing a computer to execute: an extension request receiving step of, in a distribution channel and a time slot in which the distribution channel is to be used reserved for distributing content received from a user terminal from a content distribution server to a client via a network, receiving an extension request for extending the time slot from the user terminal while the content is being distributed to the client; a reservation setting information generating step of generating new reservation setting information in which the time slot is extended in response to the extension request; and a control step of sending the new reservation setting information to the user terminal and to the content distribution server so as to allow the user terminal to continue to send the content to the content distribution server based on the new reservation setting information, and to allow the content distribution server to continue to distribute the content.

The present invention also provides a storage medium for storing the above-described content reserved-time-extension control program.

Accordingly, even if it is desired that a reserved time slot be extended since the distributing operation cannot be finished within the reserved time slot, the content can be continuously distributed without the need to suspend the distribution or to make a new reservation.

### BRIEF DESCRIPTION OF THE DRAWINGS

FIG. 1 is a schematic diagram illustrating the overall configuration of a content distribution system according to an embodiment of the present invention;

FIG. 2 is a block diagram illustrating the circuit configuration of a user PC;

FIGS. 3A and 3B are perspective views illustrating the external configurations of the user PC;

FIGS. 4A and 4B are perspective views illustrating the external configurations of the user PC;

FIG. 5 illustrates the initial screen when an application program is started in the user PC;

FIGS. 6A and 6B illustrate the overall configuration of an image-capturing mode screen;

FIGS. 7A, 7B, and 7C illustrate the overall configuration of an upload mode screen;

FIGS. 8A and 8B illustrate the overall configuration of a web check mode screen;

FIGS. 9A and 9B illustrate the overall configuration of a live reserve/check mode screen;

FIGS. 10A and 10B illustrate the overall configuration of a live distribution mode screen;

FIG. 11 is a block diagram illustrating the configuration of a server-use reservation management center;

FIG. 12 illustrates a personal casting service top page screen;

FIG. 13 illustrates a “my studio” screen;

FIG. 14 illustrates a membership registration input screen;

FIG. 15 is a flowchart illustrating a reservation registering sequence;

FIG. 16 illustrates a “my studio” start screen;

FIG. 17 illustrates a usage-regulation check screen;

FIG. 18 illustrates a new program reservation screen;

FIG. 19 illustrates a broadcast time-and-date setting screen;

FIG. 20 illustrates a settlement screen;

FIG. 21 illustrates a settling screen;

FIG. 22 illustrates the content of a reservation setting information file;

FIG. 23 illustrates an automatic-setting screen for automatically setting the reservation setting information file;

FIG. 24 illustrates a reservation completion screen;

FIG. 25 illustrates an editing selection screen;

FIGS. 26 and 27 illustrate a program guide page editing screen;

FIG. 28 illustrates an editing update screen;

FIG. 29 is a flowchart illustrating a content distribution sequence;

FIG. 30 is a block diagram illustrating a reserved-time-extension processing flow;

FIG. 31 is a flowchart illustrating a reserved-time-extension processing sequence;

FIG. 32 illustrates a reserved-time-extension procedure screen;

FIG. 33 illustrates a reserved-time-extension selection screen;

FIG. 34 illustrates a reserved-time-extension setting screen;

FIG. 35 partially illustrates a reservation list in which the reserved time slot is extended;

FIG. 36 illustrates a card information input screen;

FIG. 37 illustrates a card information authenticating screen;

FIG. 38 illustrates an automatic-setting screen after performing the setting for extending a reserved time slot;

FIG. 39 illustrates a reserved-time-extension completion screen;

FIG. 40 illustrates the content of a status window;

FIG. 41 illustrates a personal casting service top page screen when a “pickup” button is clicked;

FIG. 42 illustrates a program guide display screen;

FIG. 43 illustrates a detailed information display screen;

FIG. 44 illustrates a playback display screen;

FIG. 45 is a schematic diagram illustrating a modification of the content distribution system;

FIG. 46 is a perspective view schematically illustrating the external configuration of a cellular telephone provided with a digital camera;

FIG. 47 is a perspective view schematically illustrating a display unit of the cellular telephone shown in FIG. 46 when a camera portion is rotated; and

FIG. 48 is a block diagram illustrating the circuit configuration of the cellular telephone shown in FIG. 46.

### DESCRIPTION OF THE PREFERRED EMBODIMENTS

The present invention is described in detail below with reference to the accompanying drawings through illustration of an embodiment.

(1) Content Distribution System

(1-1) Overall Configuration of Content Distribution System

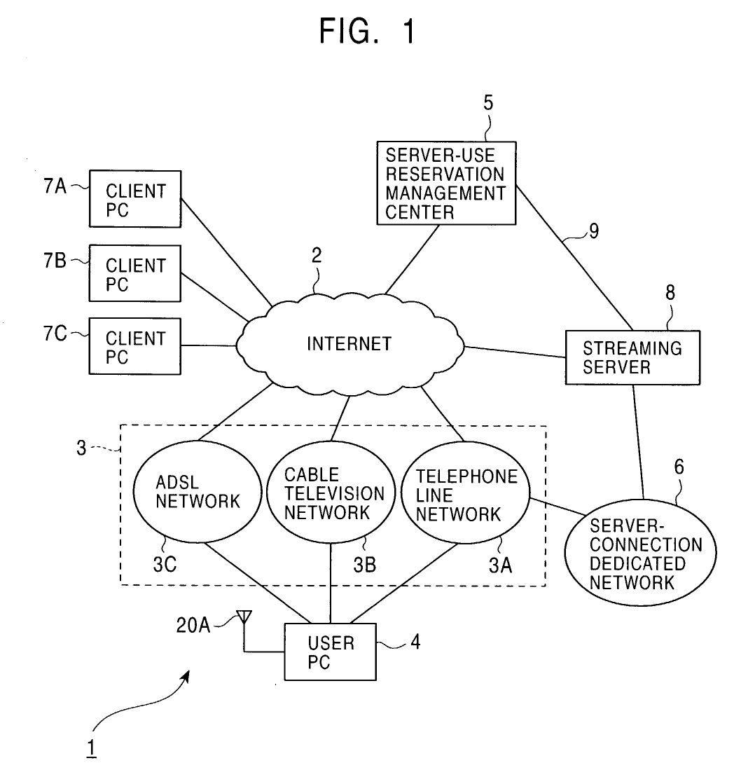

In FIG. 1, reference numeral 1 indicates a content distribution system configured in accordance with the present invention. Personal casting services, which are described below, are implemented by the content distribution system 1.

The content distribution system 1 is formed of the following elements. A user PC 4, which serves as a content provider, is connected to the Internet 2 via an Internet service provider (ISP) (not shown) and a public line network 3 (a telephone line network 3A, a cable television network 3B, or an asymmetric digital subscriber line (ADSL) network 3C). A server-use reservation management center 5 is connected to the Internet 2. A streaming server 8 distributes the content received from the user PC 4 via the public line network 3 or a server-connection dedicated network 6 to a plurality of client PCs 7A, 7B, and 7C via the Internet 2.

In this case, when transmitting the content to the streaming server 8, the user PC 4 makes, for example, a point-to-point protocol (PPP) connection with an access port of the server-connection dedicated network 6 via the telephone line network 3A of the public line network 3 so as to establish a transmission channel with the streaming server 8, thereby reliably transmitting the content to the streaming server 8 via the transmission channel.

Alternatively, the user PC 4 is able to connect to the streaming server 8 from the public line network 3 via the ISP and the Internet 2. In this case, the user PC 4 transmits the content to the streaming server 8 via a transmission channel of an available network selected from the telephone line network 3A, the cable television network 3B, and the ADSL network 3C.

The streaming server 8 transmits the content received from the user PC 4 via the server-connection dedicated network 6 or the Internet 2 to the plurality of client PCs 7A, 7B, and 7C via the Internet 2.

The streaming server 8 is also connected with the server-use reservation management center 5 via a dedicated line 9. Accordingly, when performing authentication processing, the streaming server 8 is able to send and receive authentication data to and from the user PC 4 and the client PCs 7A, 7B, and 7C via the dedicated line 9.

In practice, the user PC 4 requests the server-use reservation management center 5 to reserve the time slot when the user wishes to use the streaming distribution function of the streaming server 8. Accordingly, the user PC 4 makes a reservation for the use of the streaming server 8 via the server-use reservation management center 5.

When the reserved time is reached, the streaming server 8 receives the content transmitted from the user PC 4 via the server-connection dedicated network 6, and stores it in a buffer. At the same time, the streaming server 8 reads the content from the buffer and distributes it to the requested client PCs 7A, 7B, and 7C.

According to the above-configured content distribution system 1, a personal broadcast station, i.e., personal casting services, can be implemented in which the content transmitted from the user PC 4 is provided to the client PCs 7A, 7B, and 7C in real time via the streaming server 8 in a predetermined reserved time slot.

In this embodiment, the streaming server 8 provided with a streaming distribution function is employed. However, a server having another type of function may be used as long as it can provide the content in real time.

(1-2) Configuration of User PC

A description is now given of the configuration of the user PC 4, which is used, for example, when transmitting the content, such as live-music content, captured by a content provider, which serves as a broadcaster, to the streaming server 8.

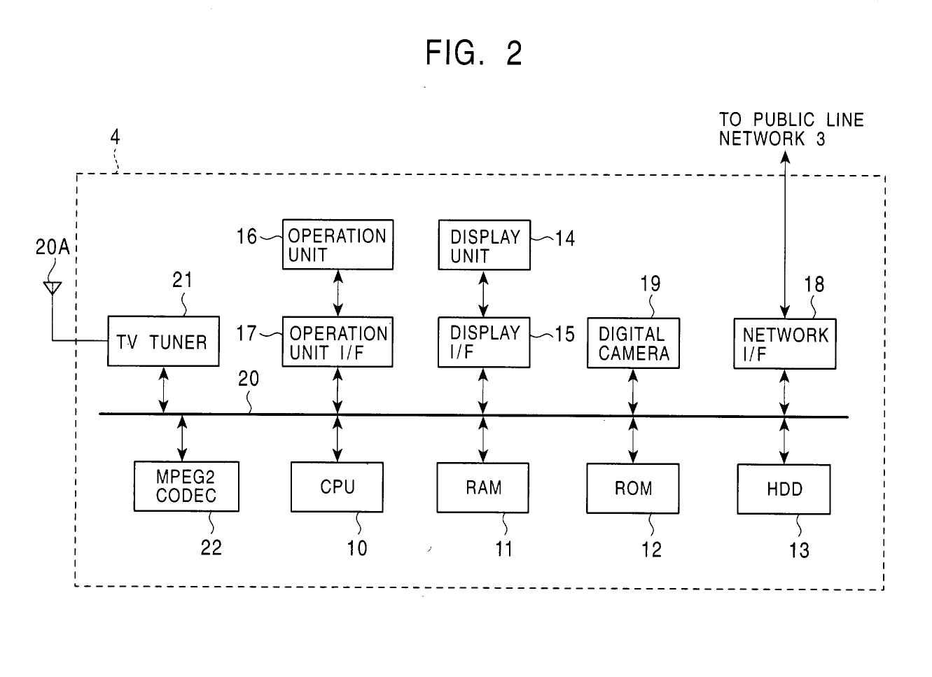

As shown in FIG. 2, the user PC 4 includes the following elements. A central processing unit (CPU) 10 executes various types of computation processing and also controls the individual circuits. A random access memory (RAM) 11 is used as a work area for the CPU 10. A read only memory (ROM) 12 stores a series of programs executed by the CPU 10. A hard disk 13 stores an operating system (for example, “Windows95/98/2000” (Microsoft Corporation)) to be executed by the CPU 10 and various programs, such as application programs. A display unit 14, such as a liquid crystal display, receives and displays the processing result obtained by the CPU 10 via a bus 20 and a display interface 15. An operation unit 16 including a keyboard, a mouse, and operating buttons, such as a rotatable and pressable jog dial (described below), is used by the content provider for inputting instructions. An operation unit interface 17 sends an instruction input from the operation unit 16 to the CPU 10 via the bus 20. A network interface 18 sends and receives via the public line network 3 data to and from an external device connected to the Internet 2 (FIG. 1) or the server-connection dedicated network 6. A digital video camera 19 is integrally attached to the user PC 4. A moving picture experts group 2 (MPEG2) codec 22 compresses the content according to the MPEG2 standards. The CPU 10 reads and writes data from and into the hard disk 13. Accordingly, the hard disk 13 is also used for storing the content and the various types of control data.

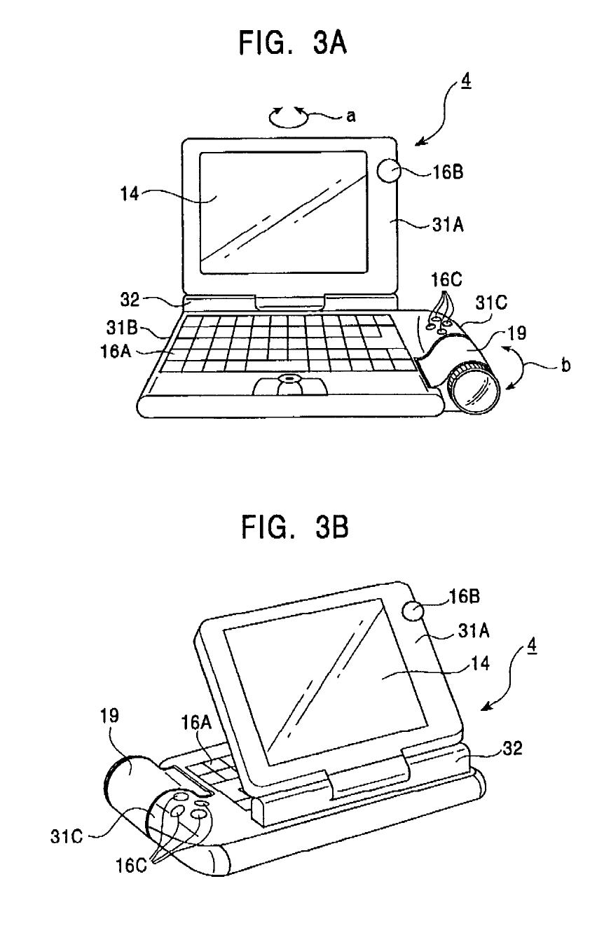

The user PC 4 includes, as shown in FIG. 3A, a display casing 31A provided with the display unit 14, such as a liquid crystal display, and a keyboard casing 31B provided with a keyboard 16A. The display casing 31A and the keyboard casing 31B are interconnected to each other so that they are pivotable via a hinge 32.

The display casing 31A is attached to the keyboard casing 31B such that it is rotatable in the directions indicated by the arrows a in FIG. 3A. The display casing 31A can also be used, as shown in FIG. 3B, in the state in which the display casing 31A is rotated by 180 degrees. A rotatable and pressable jog dial 16B is attached at the upper right side of the display casing 31A.

An operating button casing 31C on which a plurality of (four) operating buttons 16C are disposed is attached to the right side of the keyboard casing 31B. A digital video camera 19 is also supported by one point of the right side of the keyboard casing 31B such that it is rotatable in the directions indicated by the arrows b in FIG. 3A.

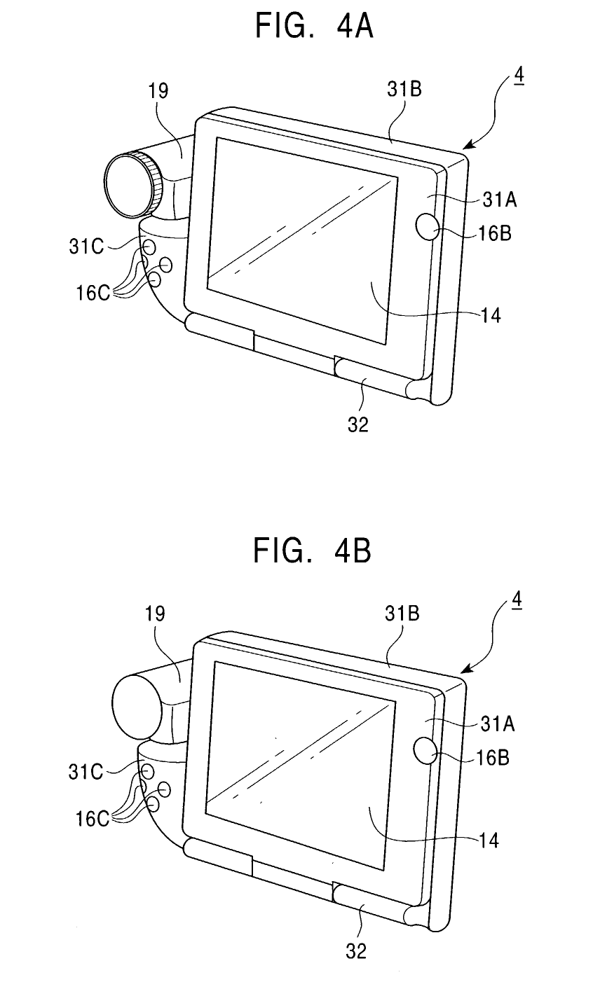

The user PC 4 can also be employed in the state shown in FIG. 4A, in which case, the content provider is able to capture an image of himself/herself by using the digital video camera 19 while holding the user PC 4. In this case, the content provider can visually check himself/herself in the display unit 14 while facing the display unit 14.

When the user PC 4 is used in this state, however, since the keyboard 16A is positioned at the back of the display unit 14, it is difficult for the content provider to correctly operate the keyboard 16A.

Considering this point, the user PC 4 is configured such that instructions concerning image capturing performed by the digital video camera 19 (for example, start, stop, zoom, add the effect, store the content, send, etc.) can be input by operating the jog dial 16B or the operating buttons 16C.

The user PC 4 can also be employed in the state shown in FIG. 4B. In this case, the content provider is able to capture an image of a subject in front of the user PC 4 by using the digital video camera 19 while holding the user PC 4 and visually checking the subject on the display unit 14.

In the user PC 4 (FIG. 2), when power is supplied, the CPU 10 reads the various programs stored in the ROM 12 or the hard disk 13 and executes them, thereby performing various types of processing, such as image capturing, content processing, sending processing of the content to the streaming server 8, and world wide web (WWW) browsing.

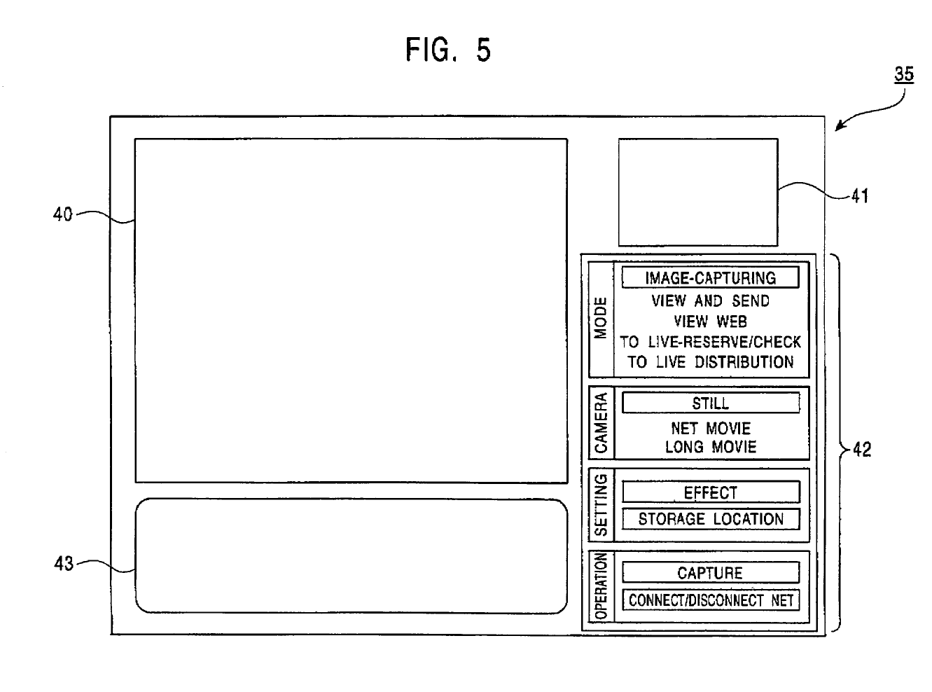

A description is now given of various functions to be implemented by executing predetermined processing by the CPU 10 of the user PC 4 according to the above-described set of programs. In the user PC 4, an initial screen 35, such as that shown in FIG. 5, is displayed on the display unit 14 under the control of the CPU 10.

The initial screen 35 is provided with a large main-image display area 40 on which an image captured by the digital video camera 19 is displayed and a small sub-image display area 41 on which a previously captured preview image is displayed. A graphical user interface (GUI) 42 for allowing the user to select one of the main items, such as “mode”, “camera”, “setting”, and “operation”, is provided below the sub-image display area 41. A status window 43 in which the various statuses of the user PC 4 are shown is provided below the main-image display area 40.

The main item, “mode”, of the GUI 42 includes five modes, such as an image-capturing mode (mode when “image-capturing” is selected), an upload mode (mode when “view and send” is selected), a web check mode (mode when “view web” is selected) a live reserve/check mode (mode when “to live-reserve/check” is selected), and a live distribution mode (mode when “to live distribution” is selected). It should be noted that the image-capturing mode is selected in the initial state when the user PC 4 is started.

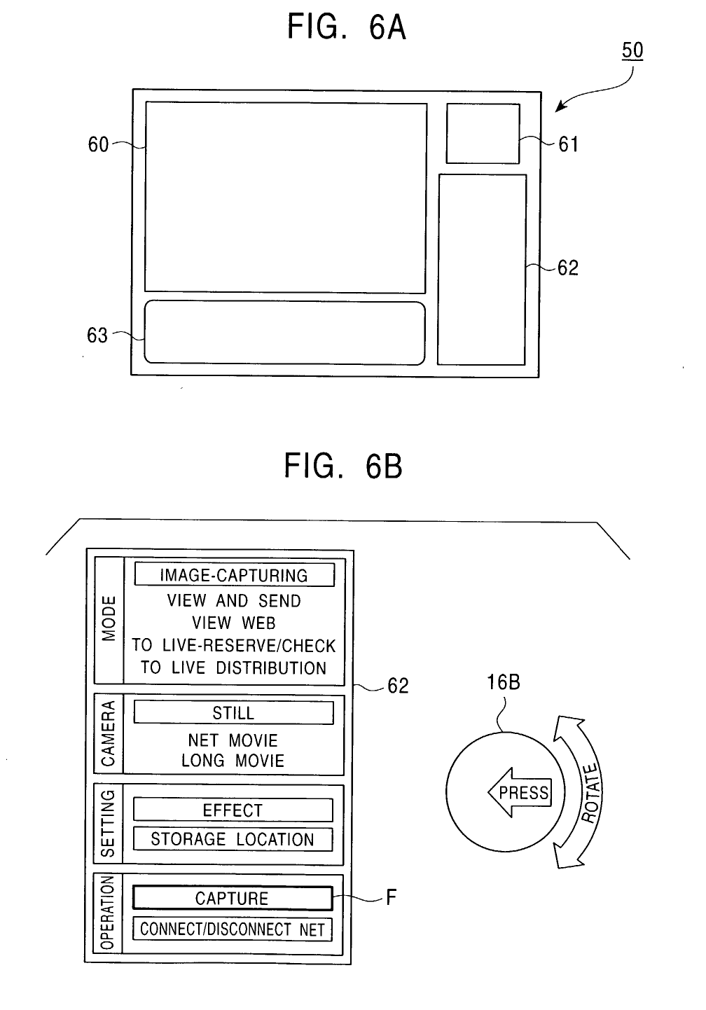

The image-capturing mode is the mode for performing image capturing by using the digital video camera 19 of the user PC 4. When the image-capturing mode is selected, or in the initial state, the CPU 10 displays an image-capturing mode screen 50, such as that shown in FIG. 6A, on the display unit 14.

As in the above-described initial screen 35 (FIG. 5), in the image-capturing screen 50, a main-image display area 60 and a sub-image display area 61 are provided, and an image which is currently captured is displayed in the main-image display area 60, and a previously captured image preview is displayed on the sub-image display area 61.

A GUI 62 similar to the GUI 42 on the initial screen 35 is displayed on the image-capturing mode screen 50. The GUI 62 is also provided with main items, such as “mode”, “camera”, “setting”, and “operation”, as shown in FIG. 6B.

Each of the main items is provided with a plurality of sub items. By rotating the jog dial 16B of the display casing 31A, a focus F indicated by the solid frame in FIG. 6B is moved on the sub items. After the focus F is moved to a desired sub item, the selected sub item can be determined by pressing the jog dial 16B.

In the image-capturing mode, predetermined commands (for example, commands for selecting and setting effect items, which produce special effects on a currently captured image) are pre-assigned to the operating buttons 16C (FIGS. 3 and 4) provided for the operating button casing 31C.

Accordingly, the content provider is able to perform various operations in the image-capturing mode simply by using the jog dial 16B or the operating buttons 16C without using the keyboard 16A. Thus, even if the user PC 4 is positioned such that it is difficult to use the keyboard 16A, for example, in the states shown in FIGS. 4A and 4B, the image-capturing operation can be easily performed.

In the image-capturing mode, commands for selecting and setting the effect items, which are used for producing special effects on a currently captured image, are pre-assigned to the operating buttons 16C as a default. Other types of commands may be pre-assigned to the operating buttons 16C, or other commands may be pre-assigned to the operating buttons 16C in another mode. In this case, the operability of the user PC 4 is significantly increased.

In the image-capturing mode, the current status of the user PC 4 (for example, the remaining amount of the battery, the storage space of the hard disk 13, etc.) and the processing state in the selected mode (for example, the data size of a currently captured image, the specified storage location, the command type assigned to the operating buttons 16C, etc.) are displayed in the status window 63.

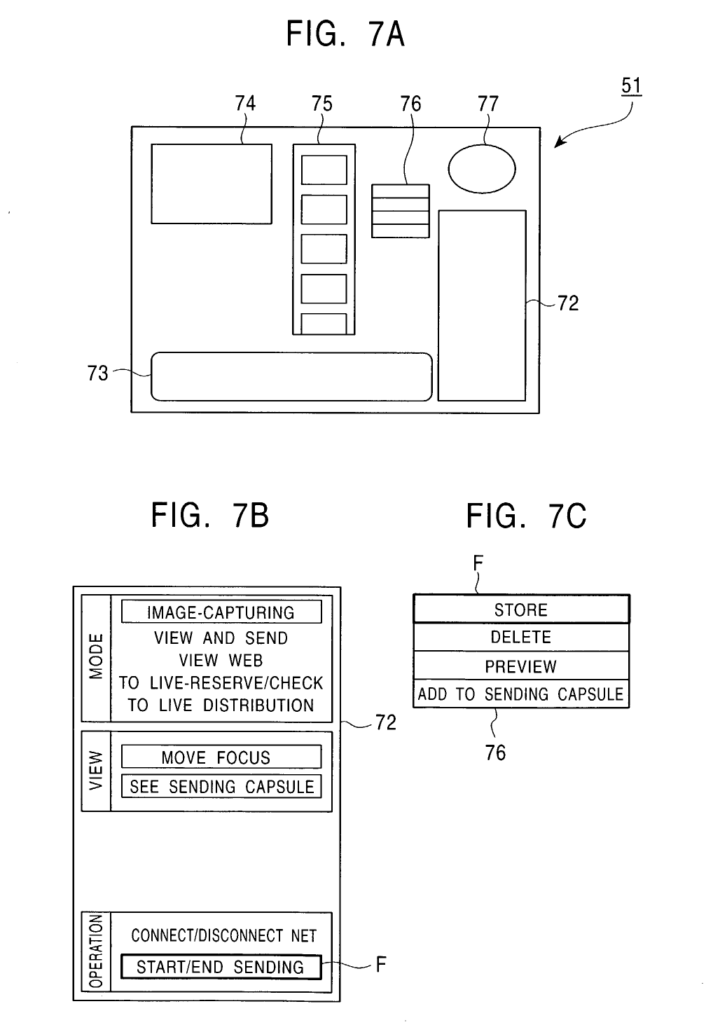

The upload mode is the mode for presenting the content captured in the above-described image-capturing mode to the content provider on the display unit 14, or sending the content image data to the streaming server 8 of a predetermined upload system connected to the Internet 2. In this case, the CPU 10 displays an upload mode screen 51 shown in FIG. 7A on the display unit 14.

The upload mode screen 51 is provided with a GUI 72 and a status window 73 similar to the counterparts of the image-capturing mode (FIG. 6A). Also, a preview area 74, a list display area 75 in which a plurality of typical still images of the items of contents are displayed, and a sending capsule icon 77 are provided for the upload mode screen 51.

In the GUI 72 of the upload mode screen 51, as shown in FIG. 7B, items, such as “mode”, “operation”, and “view”, are indicated.

The item “operation” includes sub items, such as “connect/disconnect net” for providing an instruction to connect or disconnect to or from the Internet 2 and “start/end sending” for providing an instruction to start or finish sending the content. The item “view” includes sub items, such as “move focus” for providing an instruction to move the focus F to the list display area 75 and “see sending capsule” for checking the items of content, i.e., for presenting the list of the selected items of content to the content provider.

As in the image-capturing mode 50 (FIG. 6B), in the GUI 72, the focus F is moved on the sub items by the rotation of the jog dial 16B of the display casing 31A, and after the focus F is moved to a desired sub item, the desired sub item is selected by pressing the jog dial 16B.

In the upload mode, commands for starting and stopping the playback of the content displayed in the preview area 74, and a command for providing an instruction to display a still image are pre-assigned to the operating buttons 16C (FIGS. 3A through 4B). The file name, the file size, the format (Joint Photographic Experts Group (JPEG) or MPEG) of the image data, and the information of the currently designated destination (server name and the Uniform Resource Locator (URL) to which the content is to be uploaded), etc., are displayed in the status window 73.

The CPU 10 moves the focus F to the item “move focus” according to the rotating operation on the jog dial 16B by the content provider, and, when the item “move focus” is selected by the pressing of the jog dial 16B, the CPU 10 moves the focus F to the list display area 75.

When rotating the jog dial 16B while the focus F is positioned in the list display area 75, the content provider is able to move the focus F on the still images of the list display area 75. Then, after moving the focus F to a desired still image, the content provider presses the jog dial 16B to select the desired still image to be sent.

At this time, the CPU 10 displays a sub-GUI 76 next to the list display area 75, and moves the focus F on the items of the sub-GUI 76, as shown in FIG. 7C.

The sub-GUI 76 includes items, such as “store”, “delete”, “preview”, and “add to sending capsule”. If the item “add to sending capsule“is selected with the focus F by the rotation and the pressing of the jog dial 16B, the CPU 10 adds the content selected from the list display area 75 to the list of the content in the sending capsule icon 77.

Thereafter, the focus F is returned to the GUI 72 by the content provider, and when the item “start/end sending” is selected with the focus F, the CPU 10 sends all the items of content included in the sending capsule icon 77 to a predetermined upload server.

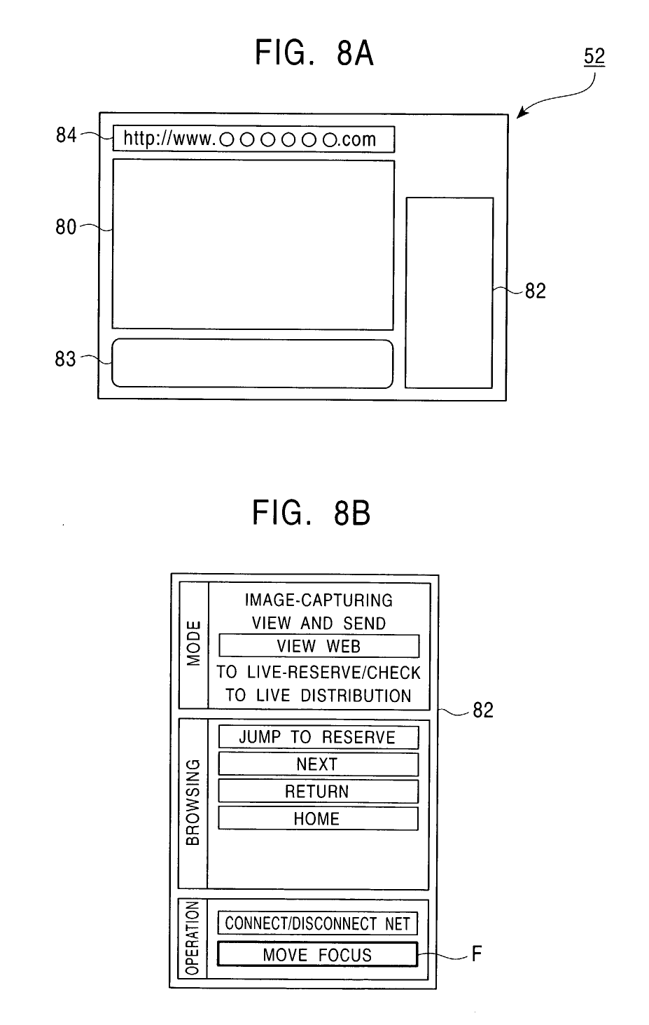

The web check mode is the mode for performing browsing by connecting the user PC 4 to the Internet 2. When the web check mode is selected, the CPU 10 displays a web check mode screen 52, such as that shown in FIG. 8A, on the display unit 14.

The web check mode screen 52 is provided with a GUI 82 and a status window 83 similar to the counterparts of the image-capturing mode screen 50 (FIG. 6A). The web check mode screen 52 is also provided with a browser display area 80 for displaying a web browser and a URL display column 84 for indicating the URL of the resource displayed in the browser display area 80.

When the web check mode is selected, the CPU 10 reads browser software (for example, Internet Explorer (Microsoft Corporation) or Netscape Navigator (Netscape)) from the hard disk 13, and executes the read software, thereby displaying a browsing image on the browser display area 80 according to the browser software.

As shown in FIG. 8B, the item “browsing” is indicated in the GUI 82 of the web check mode screen 52 instead of the items “setting” and “camera” indicated in the initial screen 35.

The item “browsing” includes sub items, such as “jump to reserve” for providing an instruction to jump to a predetermined web page, “next” and “return” for operating the browser, and so on. In this web check mode, regular browsing processing, such as inputting a URL to perform browsing, can also be executed.

As in the image-capturing screen 50, the focus F is moved to a desired sub item in the GUI 82 by the rotation of the jog dial 16B of the display casing 31A, and the desired sub item is selected by the pressing of the jog dial 16B.

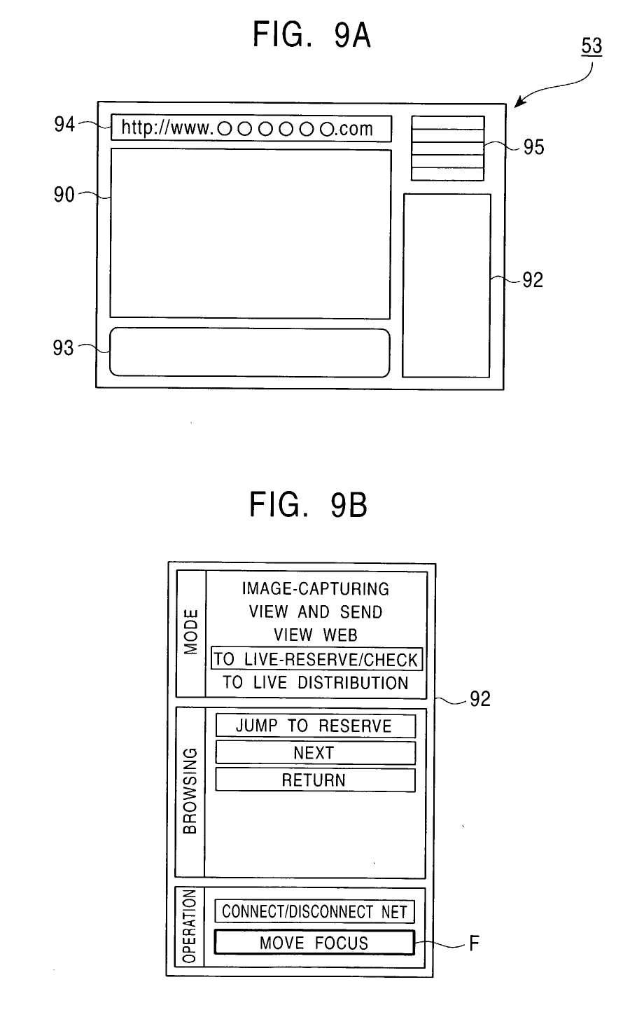

The live reserve/check mode is the mode for reserving the time slot during which a personal live broadcast of the content is performed by the stream distribution function of the streaming server 8. When the live reserve/check mode is selected, the CPU 10 displays a live reserve/check mode screen 53, such as that shown in FIG. 9A, on the display unit 14.

The live reserve/check mode screen 53 is provided with a browser display area 90, a GUI 92, a status window 93 and a URL display column 94 similar to the counterparts of the web check mode screen 52 (FIG. 8A). The live reserve/check mode screen 53 is also provided with a reserve list display area 95.

As in the GUI 82 of the web check mode screen 52 (FIG. 8B), items “mode”, “operation”, and “browsing” are provided with the live reserve/check mode screen 53, as shown in FIG. 9B. The item “browsing” includes sub items, such as “jump to reserve” for providing an instruction to jump to the predetermined web page for making a reservation for a live broadcast, “next” and “return” for operating the browser, and so on.

As in the web check mode screen 52, the focus F is moved to a predetermined sub item in the GUI 92 by the rotation of the jog dial 16B of the display casing 31A, and then, the desired sub item is selected by the pressing of the jog dial 16B.

The web page for making a live-broadcast reservation is the page on a live reserve screen stored in the hard disk of a live casting server (described below) in the server-use reservation management center 5.

When the item “jump to reserve” is selected with the focus F by the content provider, the CPU 10 of the user PC 4 accesses the live casting server of the server-use reservation management center 5 so as to send reservation request information to the live casting server or receive various data concerning live reservation, such as downloading a live-reservation setting information file from the live casting server.

In the reserve list display area 95 of the live reserve/check mode screen 53, a list of items reserved in the server-use reservation management center 5 is displayed, and summary information, such as the time slot, which is set for each item, is also displayed.

When a desired reserved item is selected with the focus F from the reserve list display area 95 by the rotation and the pressing of the jog dial 16B, the CPU 10 of the user PC 4 controls the live casting server of the server-use reservation management center 5 to jump to the web page of the reserve check screen on which details of the reserved items are indicated. The live reservation processing performed between the CPU 10 of the user PC 4 and the server-use reservation management center 5 is discussed below.

The live distribution mode is the mode for distributing the content obtained by the digital video camera 19 of the user PC 4 to the client PCs 7A, 7B, and 7C in real time via the Internet 2 by using the stream distribution function of the streaming server 8 as if the content is distributed from a personal broadcast station.

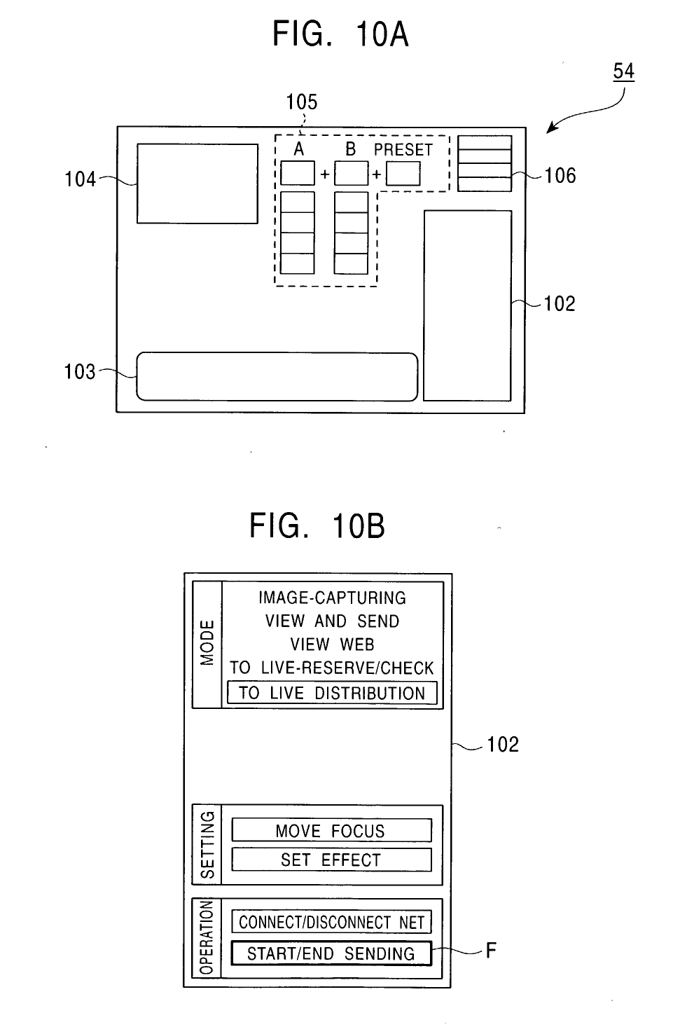

When the live distribution mode is selected by the content provider, the CPU 10 of the user PC 4 displays a live distribution mode screen 54, such as that shown in FIG. 10A, on the display unit 14.

In this live distribution mode screen 54, in addition to a GUI 102 and a status window 103, an effect-item display column 105 for allowing the user to select the type of special effect produced on moving picture data of a live distribution broadcast, a preview image display area 104 in which an effect image provided with the selected special effect is displayed, and a reserve list display column 106 in which the reserved programs are indicated. It should be noted that the effect image displayed in the preview image display area 104 is to be sent to the streaming server 8.

The status window 103 displays various items of information concerning the live distribution, such as on-air information indicating that a live broadcast is currently distributed, live distribution time information indicating the lapse of time from the live distribution start time, time information of the service provider in personal casting services, time information of the user PC 4, reserved time information indicating the reserved start time and the reserved end time, image size information, bit rate information indicating the transmission rate (bit rate) of the distribution data, title information indicating the title name of the content, connecting-server information indicating the streaming server 8 and the channel thereof, and the number-of-viewer information indicating the number of client PCs, such as the client PCs 7A, 7B, and 7C, that are currently receiving the content from the streaming server 8.

As shown in FIG. 10B, items, such as “mode”, “operation”, and “setting”, are indicated in the GUI 102 of the live distribution mode screen 54. The item “operation” includes sub items, such as “connect/disconnect net” for providing an instruction to connect or disconnect to or from the Internet 2, and “start/end distribution” for providing an instruction to start or finish the live distribution.

The item “setting” includes sub items, such as “set effect” for selecting the type of effect produced on moving picture data of the content and “move focus” for moving the focus F to the effect-item display column 105.

The sub item “set effect” is for selecting the effect item to be produced on the moving picture data of the content and for displaying the selected effect item in the effect-item display column 105.

The sub item “move focus” is for moving the focus F to the effect-item display column 105. After the focus F is moved to a desired sub item in the effect-item display column 105 according to the rotation of the jog dial 16B, the desired sub item is selected by the pressing of the jog dial 16B.

When the item “start/end distribution” is selected with the focus F by the rotation and the pressing of the jog dial 16B, the CPU 10 of the user PC 4 establishes a transmission channel with the streaming server 8 by connecting to a dedicated line via the server-connection dedicated network 6 or connecting to the Internet 2 according to the reservation setting information file for the live distribution supplied from the live casting server of the server-use reservation management center 5 in the above-described live reserve/check mode.

Subsequently, the CPU 10 of the user PC 4 transmits the moving picture data of the content captured by the digital video camera 19 to the streaming server 8 in real time according to the details (for example, data transmission rate) set in the reservation setting information file.

As discussed above, the user PC 4 stores an application program provided with five functions, such as the image-capturing mode, the upload mode, the web check mode, the live reserve/check mode, and the live distribution mode, in the hard disk 13. The user PC 4 also stores an application program for automatically incorporating a reservation setting information file (described below) required for making a live distribution reservation, and an application program for executing the processing for connecting to the streaming server 8 for performing live distribution. Details of the functions implemented by executing such application programs are discussed below.

(1-3) Configuration of Server-Use Reservation Management Center

As discussed above, when the user PC 4, as a live distributor, sends the moving picture data of the content to the streaming server 8, it is necessary to make a reservation for using the streaming distribution function of the streaming server 8 in a scheduled time slot in the personal casting services implemented by the content distribution system 1.

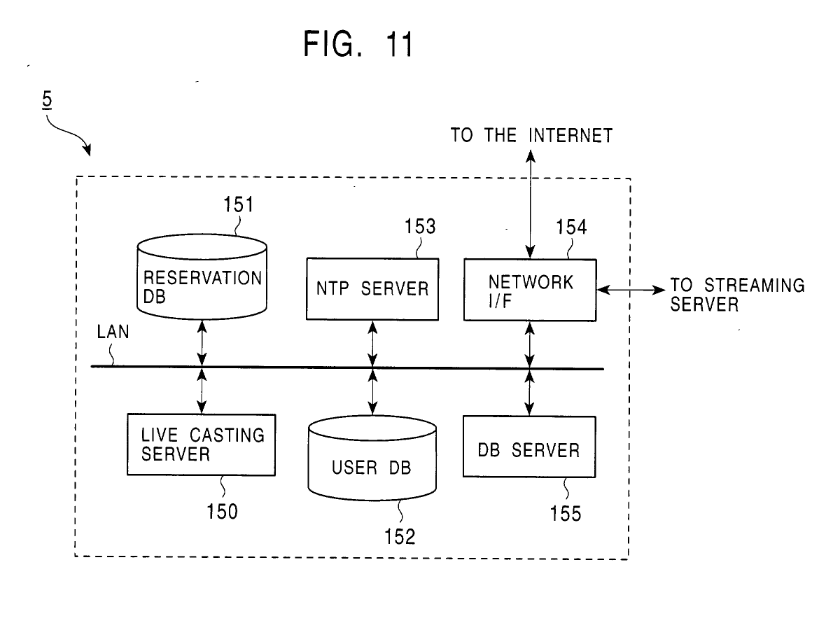

A description is now given, with reference to FIG. 11, of the server-use reservation management center 5, which serves as a service provider, for managing reservations for the streaming server 8.

The server-use reservation management center 5 is formed of a live casting server 150, a reservation database 151, a user database 152, a network time protocol (NTP) server 153, a network interface 154, and a database server 155. These items are connected to each other via a LAN.

The server-use reservation management center 5 sends and receives data to and from the user PC 4 and the client PCs 7A, 7B, and 7C connected to the Internet 2 via the network interface 154, and also communicates with the streaming server 8 connected to the dedicated line 9 (FIG. 1).

The live casting server 150 manages the overall personal casting services, such as live distribution reservations, billing, and membership registration, in the personal casting services.

The live casting server 150 stores in the hard disk a registration web page for allowing a content provider to obtain the right to receive the personal casting services, a reservation-receiving web page for receiving reservations for live distribution performed by the content provider, a reservation-checking web page for checking or changing reservations by the content provider, and a program guide web page for presenting a program table of live distribution broadcasts to the client PCs 7A, 7B, and 7C. When there is a demand from the user PC 4 or the client PC 7A, 7B, or 7C, the live casting server 150 sends the corresponding web page to the user PC 4 or the client PC 7A, 7B, or 7C.

The reservation database 151 stores the live-distribution reservation statuses of the content reserved in the above-described live reserve/check mode and also stores reservation billing information.

In this case, the reservation database 151 stores a reservation table (not shown) in which reservation details including the reserved time slot, the channel, the transmission band (bit per second (BPS)), etc., the user ID for identifying the user, billing flag information indicating whether the reserved item is billable, and the reservation ID used for performing authentication when a reservation is made are indicated in correspondence with each other according to the individual reserved items.

The various types of information indicated in the reservation table are written into the reservation database 151 when the reservation processing, which is discussed below, is performed by the live casting server 150, and such information is checked when the authentication processing, which is discussed below, is performed by the database server 155.

The user database 152 stores user information concerning the registered users having the right to enjoy the personal casting services (the content provider to provide the content via the user PC 4 or the client users to receive the content via the client PCs 7A, 7B, and 7C). More specifically, the user database 152 stores items for each registered user, i.e., the name, the user ID, the password, the e-mail address, the address, the telephone number (including the cellular telephone and the facsimile number), the credit card number, and the expiration period thereof.

The user information stored in the user database 152 is written when the membership registration processing, which is discussed below, is performed by the live casting server 150, and the user information is checked when the live distribution reservation, which is discussed below, is performed by the live casting server 150.

The NTP server 153 centrally manages the time information in the service providers, such as the server-use reservation management center 5 and the streaming server 8. Accordingly, the live casting server 150 and the streaming server 8 obtain the time information from the NTP server 153, and manages the start time and the end time of the live distribution based on the obtained time information.

It is necessary to perform such precise time control because services, such as live distribution, must be provided at the exact time. Thus, the reference time is uniquely determined in the service providers, and the server-use reservation management center 5 and the streaming server 8, which serve as the service providers, are operated together based on the same reference time.

There may be a difference between the time in the user PC 4 and the reference time in the service providers. If the user PC 4 does not identify this difference, there may be a time difference between the start time and the end time of the live distribution specified by the service providers and those assumed by the user PC 4.

Accordingly, the live casting server 150 calculates the above-described time difference based on the reference time obtained from the NTP server 153, and informs the user PC 4 of the calculated time difference when the user PC 4 makes a live distribution reservation.

When a connection request to use the streaming server 8 is made from the user PC 4 or another illegal user PC to the access port of the server-connection dedicated network 6, the database server 155 performs authentication processing based on a request from an access server (not shown) of the server-connection dedicated network 6 to check whether the corresponding PC is the legal user PC 4 which has actually made a reservation in the corresponding time slot.

When the database server 155 authenticates the PC (in this case, the user PC 4) as a legal user in the above-described authentication processing, a communication connection is established between the streaming server 8 and the user PC 4, and the user PC 4 requests the streaming server 8 to perform stream distribution processing.

In this case, the streaming server 8 requests the database server 155 to perform authentication processing to check whether the user PC 4 is a legal user PC which has actually made a reservation.

Accordingly, in response to a request from the streaming server 8, the database server 155 performs authentication processing. The database server 155 performs authentication processing by referring to the reservation database 151, and details of the authentication processing are given below.

(1-4) Configuration of Streaming Server

As discussed above, the streaming server 8 receives the moving picture data transmitted from the legal user PC 4 via a transmission channel established by connecting to a dedicated line (via the server-connection dedicated network 6) or to the Internet 2 (via the public line network 3), and distributes the data to the client PCs 7A, 7B, and 7C which have requested the streaming server 8 to distribute the content.

The streaming server 8 includes a plurality of channels for a plurality of corresponding distribution environments, i.e., according to whether the streaming server 8 is connected to the dedicated line or the Internet 2. With this configuration, even if a plurality of content providers access the streaming server 8 as live distributors in the same time slot, the streaming server 8 is able to perform the live distribution processing so that the content providers can distribute the content at the same time.

In practice, in the streaming server 8, the maximum number of users to which the content is to be distributed, the transmission band (for example, 20 kbps, 34 kbps, 45 kbps, 80 kbps, 220 kbps, etc.), and the usage fee are preset according to the individual channels. Then, the content distributor for performing live distribution via the streaming server 8 is able to select a desired distribution channel.

As discussed above, the streaming server 8 distributes the moving picture data of the content transmitted from the user PC 4, which serves as a content provider. The streaming server 8 also reads commercial content from, for example, the hard disk 13, and distributes it in an unoccupied time slot or in a time slot between time slots used for distributing the content.

The streaming server 8 also manages the reserved time slots and the number of client PCs to which the content is to be distributed according to the reservation details determined between the user PC 4 and the server-use reservation management center 5.

(1-5) Communication Connection between Streaming Server and User PC for Live Distribution

In the content distribution system 1, when performing live distribution, it is necessary to connect the user PC 4 and the streaming server 8 (FIG. 1) via the dedicated line or the Internet 2 so as to ensure a transmission channel for transmitting the content from the user PC 4 to the streaming server 8.

If the user PC 4 possesses a distribution environment which allows the connection not only to the telephone line network 3A, but also to the cable television network 3B or the ADSL network 3C, the user PC 4 selects a desired line from the public line network 3 so as to transmit the content to the streaming server 8 through a transmission channel via the dedicated line or the Internet 2.

The server-connection dedicated network 6 is the network specifically used for performing live distribution in the personal casting services provided by the content distribution system 1.

As described above, in the content distribution system 1, the dedicated line or the Internet 2 is suitably selected for connecting the user PC 4 and the streaming server 8 according to the distribution environment of the user PC 4. Thus, the content provider is able to select the optimal distribution channel when making a reservation according to the distribution environment of the user PC 4.

In response to a request from a user to connect to the server-connection dedicated network 6, the access server of the server-connection dedicated network 6 requests the database server 155 (FIG. 11) to perform authentication processing to check whether the user PC 4 has a legal reservation.

If it is determined that the user PC is an unauthorized user PC based on the result of the authentication processing performed by the database server 155, the access server of the server-connection dedicated network 6 immediately disconnects the call from the PC.

However, even though a request from an authorized user PC is rejected, one of the lines of the server-connection dedicated network 6 becomes busy while authentication processing is performed.

Thus, if the maximum number of users who can access the server-connection dedicated network 6 is the same as the number of preset lines, the legal user PC 4 cannot connect to the server-connection dedicated network 6 when an unauthorized user simultaneously makes a plurality of calls to the access ports of the server-connection dedicated network 6 for the purpose of interfering with the personal casting services.

In the content distribution system 1, when providing personal casting services, the user PC 4 may be allowed to connect to the streaming server 8 before the live distribution start time according to the reservation details. In this case, the authentication processing and connection processing are performed on the user PC 4 before the live distributions start time, and when the live distribution start time is reached, the live distribution processing can be started via the user PC 4.

In this case, too, however, if, for example, continuous time slots are reserved by different users, the connection of the content provider who has reserved the earlier time slot and is currently distributing the content conflicts with the connection of the subsequent content provider who has reserved the later time slot and attempts to connect to the streaming server 8 before the live distribution start time. Accordingly, if the number of lines is the same as the maximum number of users, some users may not be able to connect to the streaming server 8 in such a situation.

Thus, the streaming server 8 sets the number of lines through which the users can be connected to the streaming server 8 to about twice as much as the maximum number of users who are allowed to connect to the streaming server 8 in the same time slot (for example, if the maximum number of users is 10, the number of lines is set to 20). With this arrangement, it is possible to reduce conflicts on the provision of services by the interference of unauthorized users. Also, even if one user who has reserved the earlier time slot conflicts with another user who has reserved the later time slot attempt to connect to the streaming server 8 at the same time, the conflict in the same line can be sufficiently prevented.

The server-connection dedicated network 6, which is used for connecting to the streaming server 8, is not restricted to the access ports to a network (for example, a public telephone network) of a single telecommunications carrier. Alternatively, access ports to the networks of a plurality of telecommunications carriers may be prepared.

In this case, the user PC 4 selects a desired telecommunications carrier to call the corresponding access port, thereby establishing the communication connection with the streaming server 8 via the server-connection dedicated network 6.

(1-6) Configuration of Client PC

As described above, the moving picture data of the content transmitted from the user PC 4 to the streaming server 8 in real time is distributed to the client PCs 7A, 7B, and 7C, which have requested the content, via the Internet 2.

Upon receiving the content from the streaming server 8, the client PCs 7A, 7B, and 7C are able to play back the content in real time by using a predetermined application program (for example, “Real Player” (RealNetworks), or “Windows Media Player” (Microsoft Corporation)).

(2) Operation of Content Distribution System

A description is given below of various types of processing performed in the content distribution system 1 for implementing the live casting services.

(2-1) Membership Registration

When performing live distribution by using the personal casting services, the content provider of the user PC 4 is required to conduct a membership registration procedure in the live casting server 150 of the server-use reservation management center 5 in order to obtain the right to perform live distribution in the personal casting services.

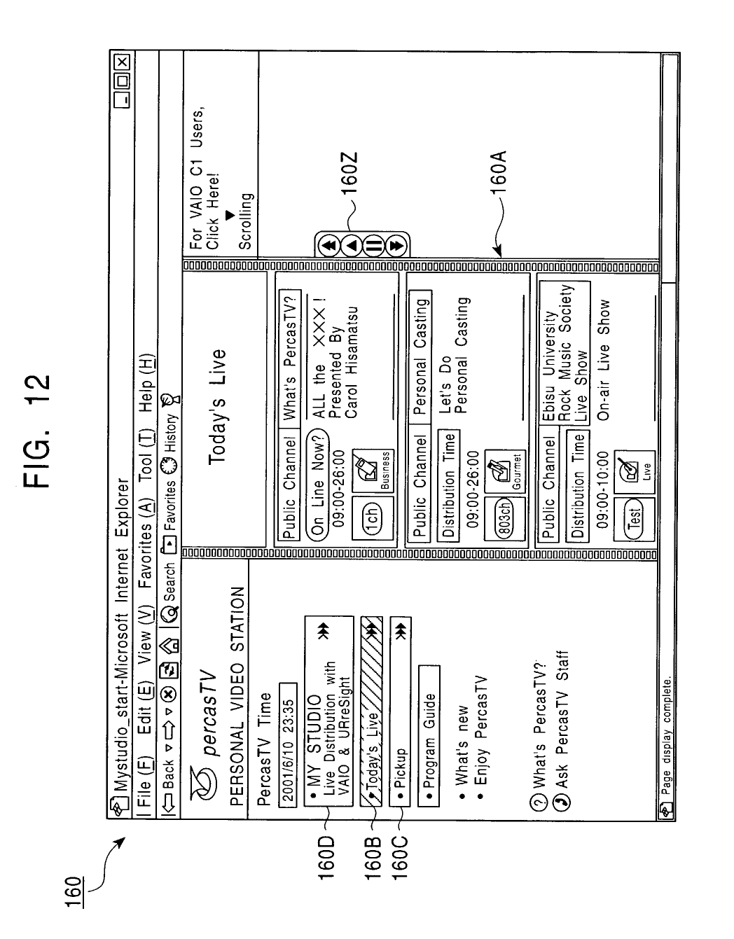

More specifically, the user PC 4 requests the live casting server 150 to view a personal casting service top page based on the URL directly input by the content provider in the URL display column 84 of the web check mode screen 52 (FIG. 8). Then, a personal casting service top page screen 160, such as that shown in FIG. 12, received from the live casting server 150, is displayed on the browser display area 80.

When requesting the live casting server 150 to view the personal casting service top page, the content provider may click the link button on the home page rather than inputting the URL, thereby allowing the content provider to jump to the personal casting service top page screen 160.

A program guide display area 160A, which is similar to a film roll, is provided substantially at the center of the personal casting service top page screen 160, and is scrolled in a ring-like shape in the vertical direction at a predetermined speed.

As a default, the program guide display area 160A shown when a “today's live” button 160B is clicked is set. The title “today's live (today's program)” and guide information of the programs (content) to be distributed that day are displayed by being sequentially scrolled in a ring-like shape as one of the film frames.

In the personal casting service top page screen 160, the scrolling direction of the program guide display area 160A can be changed or the scrolling operation can be stopped by clicking operating buttons 160Z. With this arrangement, the client user can easily select the guide information of a desired program, and can also visually check the information when the scrolling is stopped.

A “my studio” button 160D is also provided on the personal casting service top page screen 160, and when clicking the “my studio” button 160D, the web page hyperlinked to the “my studio” button 160D is sent from the live casting server 150 to the user PC 4.

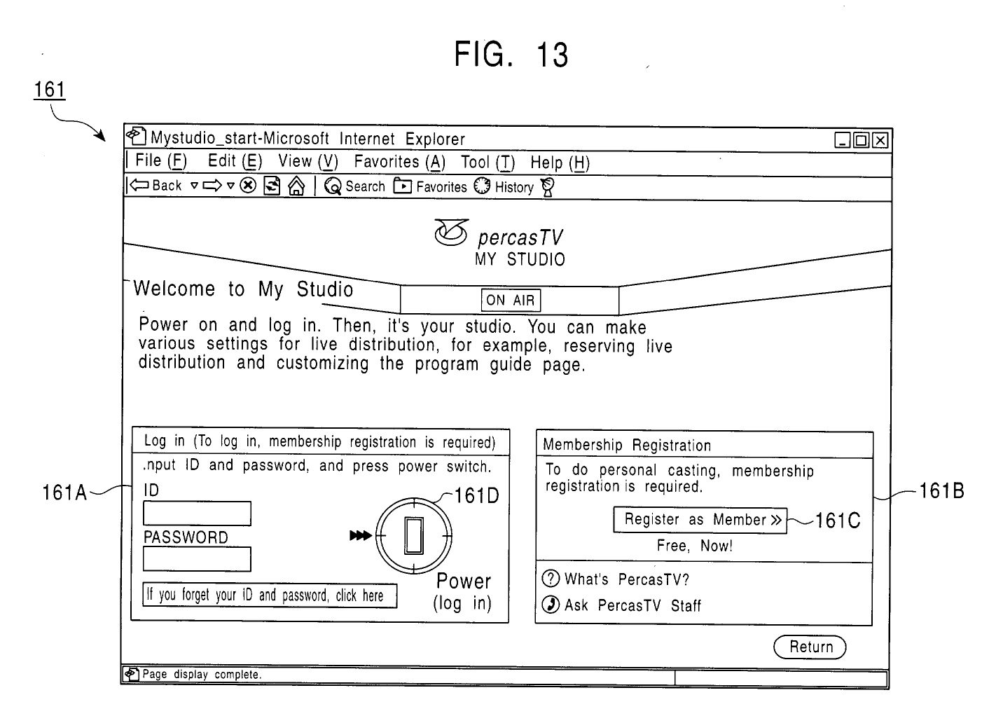

The CPU 10 of the user PC 4 displays a “my studio” screen 161, such as that shown in FIG. 13, based on the web page received from the live casting server 150.

The “my studio” screen 161 is provided with a log-in display column 161A for instructing registered members to log in, and a membership registration column 161B for unregistered users. The registered members are instructed to input their user ID and the password in the log-in display column 161A. The unregistered users are instructed to click a “register as a member” button 161C in the membership registration column 161B so as to perform membership registration via the subsequent membership registration screen (not shown).

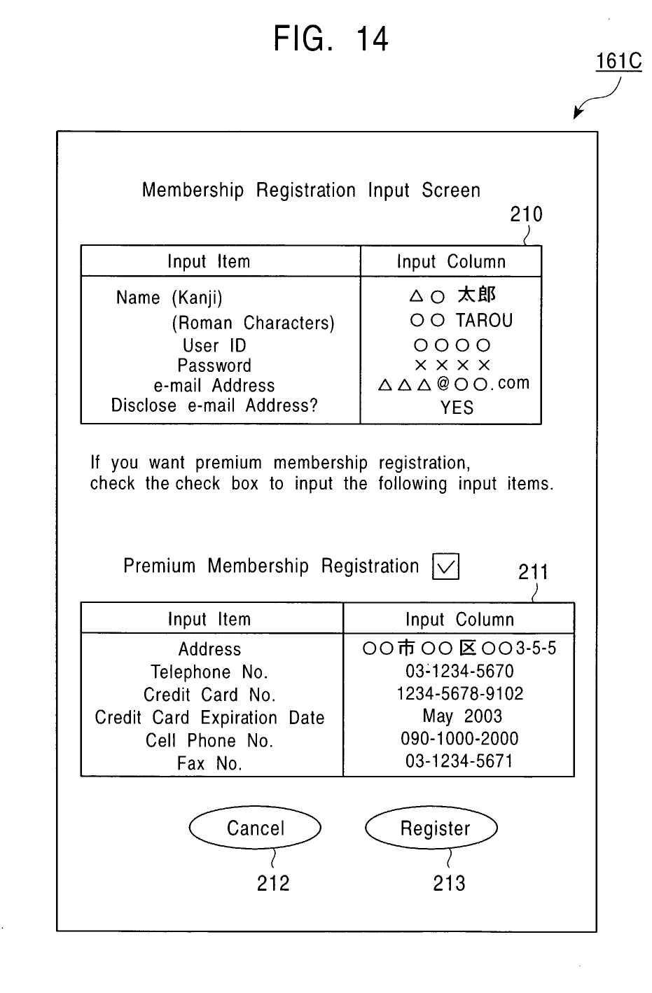

When the “register as a member” button 161C in the membership registration column 161B is clicked in the “my studio” screen 161, the CPU 10 of the user PC 4 receives the subsequent web page from the live casting server 150, and displays a membership registration input screen 161C, such as that shown in FIG. 14, based on the web page.

The membership registration input screen 161C is provided with input items and the corresponding input columns for performing membership registration.

In the personal casting services, two types of membership registrations are prepared, i.e., regular-membership registration simply for receiving live distribution from the streaming server 8 by using the above-described function of the client PCs 7A, 7B, and 7C, and premium-membership registration not only for receiving the live distribution, but also for using the personal casting services as live distributors. Accordingly, a regular/premium input column 210 and a premium exclusive input column 211 are provided in the membership registration input screen 161C.

In this membership registration input screen 161C, client users intending to register as regular members fill in the regular/premium input column 210 by using the client PCs 7A, 7B, and 7C.

In the membership registration input screen 161C, a cancel button 212 for canceling the input information, and a registration button 213 for registering the input information are provided. When the registration button 213 is clicked, the client PCs 7A, 7B, and 7C send the information filled in the input column 210 to the live casting server 150 via the Internet 2 as registration information.

When performing premium membership registration, the content provider checks the check box of the “premium membership registration”, and fills in the input columns 210 and 211.

When the registration button 213 is clicked after inputting the items into the input columns 210 and 211 by the content provider, the CPU 10 of the user PC 4 creates a registration information file having the same content as the membership registration screen 161, and sends it to the live casting server 150 via the Internet 2. The CPU 10 also writes the registration information file into the hard disk 13.

Upon receiving the registration information file from the user PC 4 via the Internet 2, the live casting server 150 checks the content of the registration information file and determines whether to accept the registration.

In this case, if there is a blank item in which information is not filled, the live casting server 150 instructs the user PC 4 to re-input the information.

The live casting server 150 also accesses a credit check server of a credit company via the Internet 2 and checks whether the credit card in the registration information file is valid, and if so, the live casting server 150 accepts the registration.

When the registration is permitted, the live casting server 150 performs membership registration processing by writing the individual items of information into the user database 152, and then informs the user PC 4 via the Internet 2 that the membership registration processing has been completed.

(2-2) Distribution Reservation Registration

Upon completion of the above-described membership registration processing, the content provider of the user PC 4 performs reservation registration processing for reserving the time slot for distributing the content to the streaming server 8. This reservation registration processing is performed for the live casting server 150 of the user-use reservation management center 5.

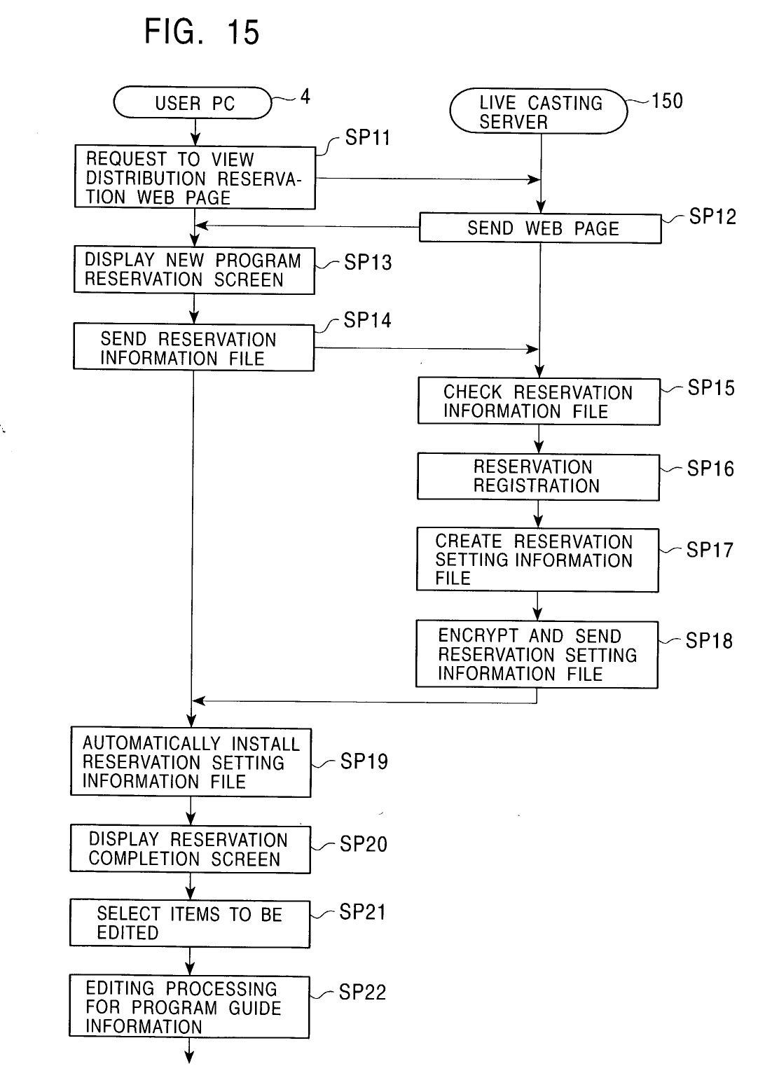

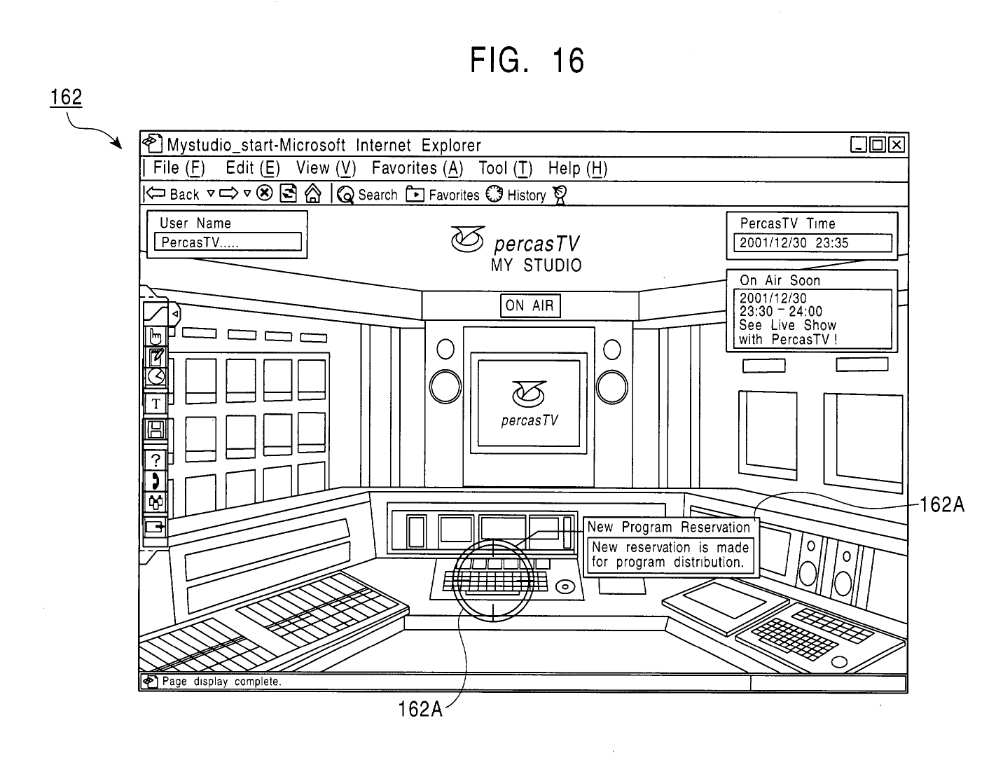

The reservation registration processing is discussed below with reference to the flowchart of FIG. 15. In step SP11, after the completion of the membership registration processing, the content provider inputs the user ID and the password in the log-in display column 161A of the “my studio” screen 161 (FIG. 13) as a registered member. When a power switch button 161D is clicked, the CPU 10 of the user PC 4 performs log-in processing for the live casting server 150 of the server-use reservation management center 5, and displays a “my studio” start screen 162, such as that shown in FIG. 16, based on the subsequent web page received from the live casting server 150.

The “my studio” start screen 162 is a simulated studio of a broadcast station, and a new program reservation button (indicated by the double circles in FIG. 16) 162A for making a new program reservation is disposed substantially at the center of the “my studio” start screen 162. When the new program reservation button 162A is clicked, the processing is shifted to the new program registration procedure.

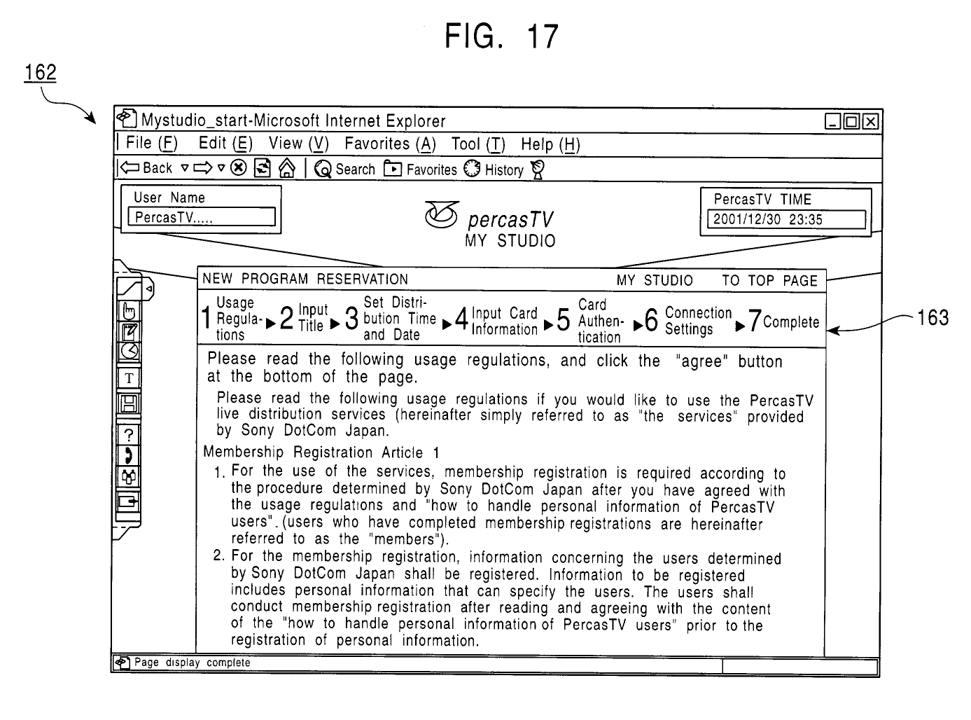

When the new program reservation button 162A is clicked, the CPU 10 of the user PC 4 receives the subsequent web page from the live casting server 150, and displays a usage-regulation check screen 163, such as that shown in FIG. 17, based on the web page. The usage-regulation check screen 163 is displayed such that it is overlaid on the “my studio” start screen 162.

In this usage-regulation check screen 163, usage regulations for receiving the personal casting services and various regulations for membership registration are indicated. When an area in which “agree” is indicated (not shown) is clicked after the user checks the regulations, the CPU 10 of the user PC 4 requests the live casting server 150 to send the distribution reservation web page, and the process proceeds to step SP12.

In step SP12, upon receiving the request from the user PC 4, the live casting server 150 sends the distribution reservation web page to the user PC 4 via the Internet 2, and the process proceeds to step SP13.

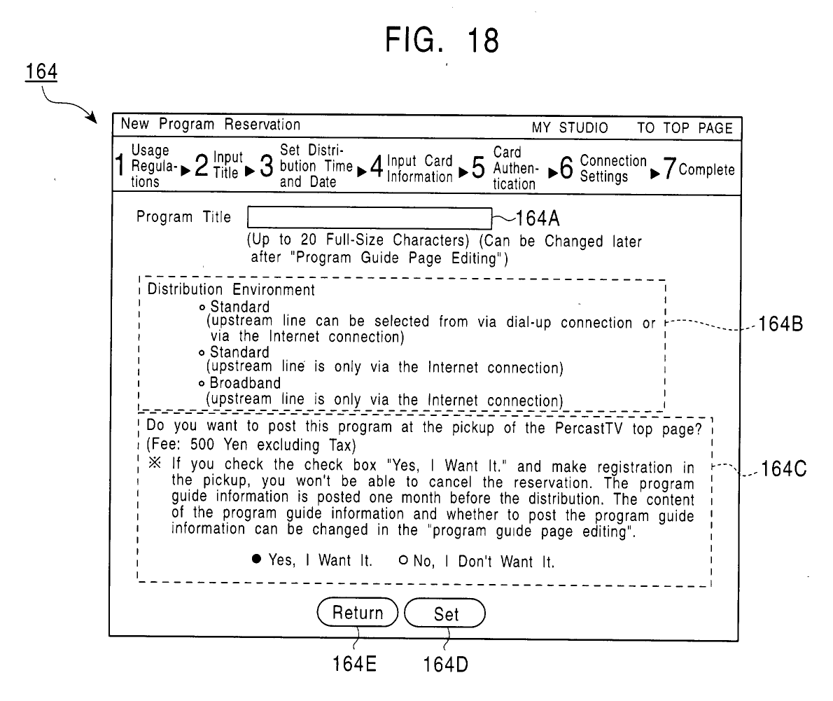

In step SP13, the user PC 4 receives the distribution reservation web page from the live casting server 150, and displays a new program reservation screen 164, such as that shown in FIG. 18, instead of the usage-regulation check screen 163 based on the distribution reservation web page such that it is overlaid on the “my studio” start screen 162.

The new program reservation screen 164 is provided with a program title input column 164A in which the program title of the content to be distributed is input by the content provider, a distribution environment setting column 164B, and a program announcement setting column 164C for selecting whether the program guide information of the content is to be posted on the program guide display area 160A of the personal casting service top page 160.

The program title input in the program title input column 164A is posted on the program guide display area 160A of the personal casting service top page screen 160. The program title may be changed later in the program guide page editing screen (discussed below) by the content provider.

In the distribution environment setting column 164B, three check columns, i.e., “standard (upstream line can be selected via the dial-up connection or the Internet connection)”, “standard (upstream line is only via the Internet connection)”, and “broadband (upstream line is only via the Internet connection)”, are provided. The user PC 4 is able to select the adaptable environment from these three types.

In the program announcement setting column 164C, two types of check columns, i.e., “Yes, I Want it” and “No, I Don't Want it” are provided. If the check column “Yes, I Want it” is checked, the program guide information including the program title is posted in the program guide display area 160A for one month until the day when the program is distributed by clicking a “pickup” button 160C in the personal casting service top page screen 160 (FIG. 12).

However, even if the check column “No, I Don't Want it” is checked, the program guide information for the content to be distributed is posted in the program guide display area 160A on the day when the program is distributed if the “today's live” button 160B of the live casting service top page screen 160 is clicked.

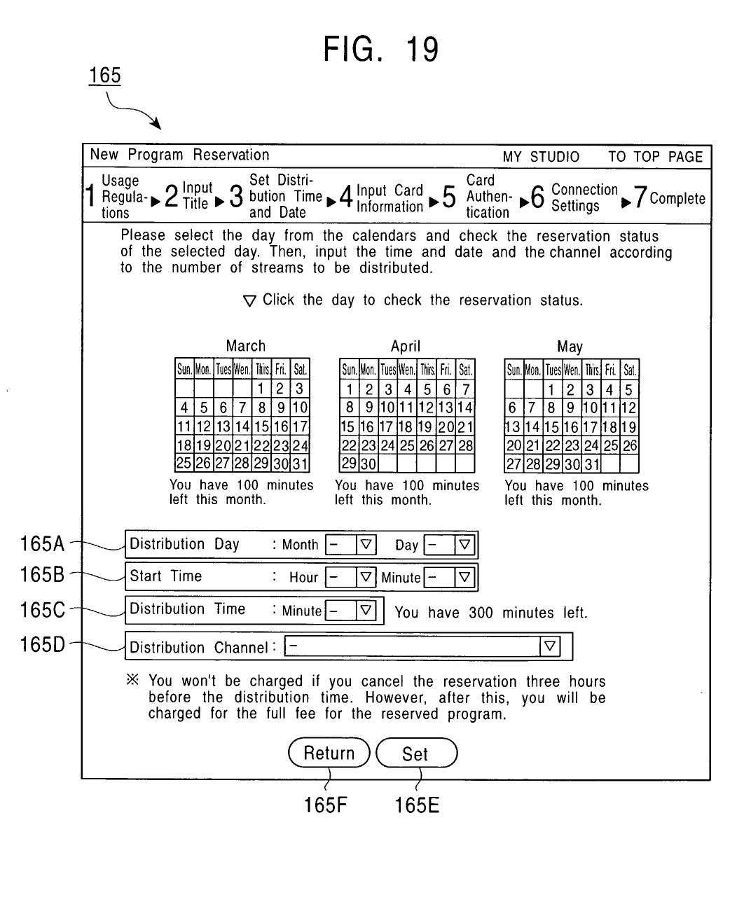

Then, when a “set” button 164D is clicked after completing the new program reservation in the new program reservation screen 164, such as inputting the program title, selecting the distribution environment, and determining whether the program announcement is to be posted, the CPU 10 of the user PC 4 displays a broadcast time-and-date setting screen 165, such as that shown in FIG. 19, based on the subsequent web page received from the live casting server 150 such that it is overlaid on the “my studio” start screen 162.

When a “return” button 164E is clicked, the CPU 10 of the user PC 4 returns to the previous usage-regulation check screen 162 rather than proceeding to the broadcast time-and-date setting screen 165.

In the broadcast time-and-date setting screen 165, the day when the program is to be distributed can be selected from the time table (calendar). When the desired day is clicked in the calendar, it is automatically set in a distribution day input column 165A.

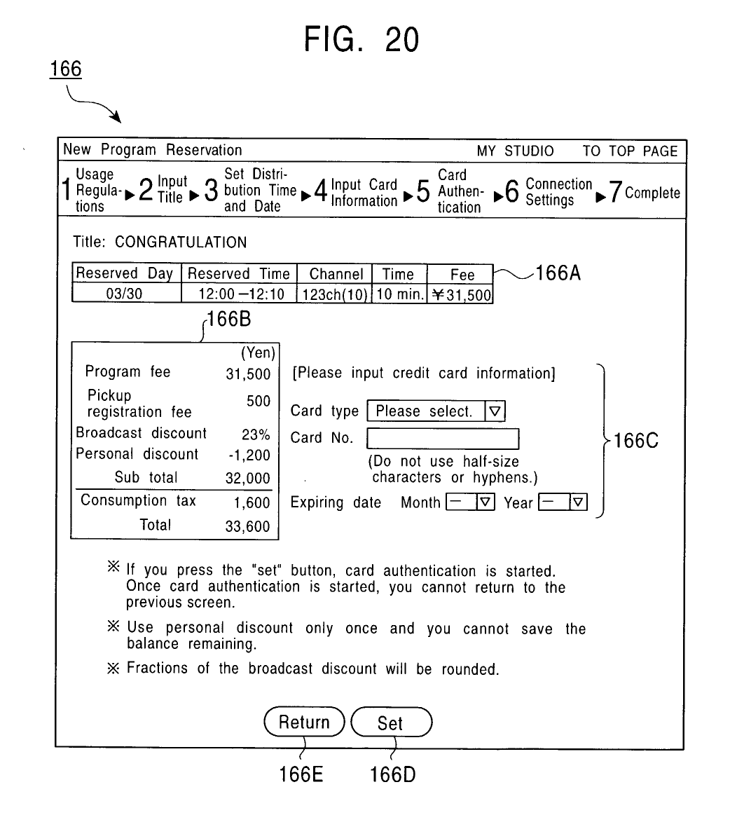

In the broadcast time-and-date setting screen 165, the distribution day in the distribution day input column 165A, the start time, the distribution time, and the distribution channel are input in a start time input column 165B, a distribution time input column 165C, and a distribution channel input column 165D, respectively. Then, a “set” button 165E is clicked. The CPU 10 of the user PC 4 then receives the subsequent web page from the live casting server 150, and displays a settlement screen 166, such as that shown in FIG. 20, such that it is overlaid on the “my studio” start screen 162.

In the settlement screen 166, “reserved day”, ” reserved time”, “channel”, “time”, and “fee”, which correspond to the “title” (“CONGRATULATION” in FIG. 20) input in the program title input column 164A of the new program reservation screen 164, are displayed in a reserved-content display column 166A. In a fee display column 166B, the total amount of the fee including the program fee, the pickup registration fee charged for the program announcement, and the predetermined discounts are displayed. The content provider is then able to check the reserved time slot and the fees.

In the settlement screen 166, the content provider is instructed to input credit card information in a credit card information input column 166C, and then to click a “set” button 166D or a “return” button 166E.

In step SP14, when the “set” button 166D in the settlement screen 166 is clicked, the CPU 10 of the user PC 4 creates the reservation information file based on the various items of information set in the new program reservation screen 164 (FIG. 18), the broadcast time-and-date setting screen 165 (FIG. 19), and the settlement screen 166 (FIG. 20), and sends the reservation information file to the live casting server 150 via the Internet 2. The process then proceeds to step SP15.

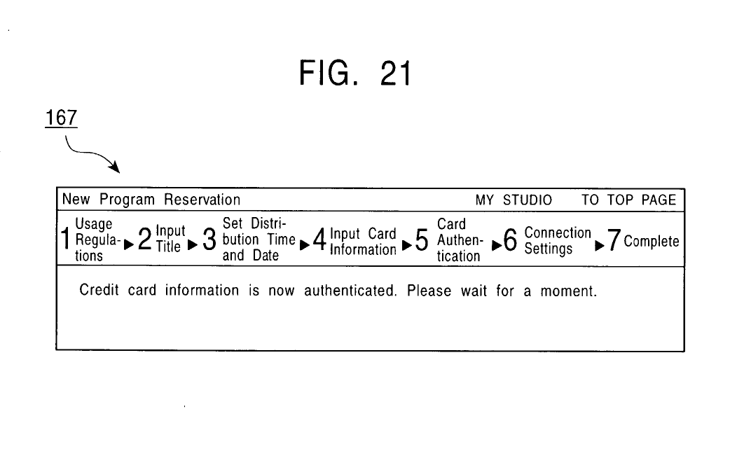

Then, the CPU 10 of the user PC 4 displays a settling screen 167, such as that shown in FIG. 21, so as to inform the content provider that authentication is currently being performed on the credit card information by the live casting server 150.

In step SP15, the live casting server 150 checks the content of the reservation information file received from the user PC 4, and determines whether the reservation is to be accepted. The process then proceeds to step SP16.

More specifically, in step SP15, the live casting server 150 checks whether the information input in the reservation information file is sufficient and whether the reserved time slot in the distribution channel is available, and also checks whether the corresponding content provider has not yet reserved frames exceeding a preset number of frames.

In the live casting services, the maximum number of frames that can be reserved (for example, 10 minutes for each frame) for one month is set for a content provider.

Accordingly, the live casting server 150 checks whether the number of frames which have been reserved by the content provider for the last month does not exceed the predetermined number of frames. If the content provider has reserved more than the predetermined number of frames, the live casting server 150 does not accept the reservation from this content provider.

If the number of frames which have been reserved for the last month does not exceed the predetermined number of frames, and if there is no problem for the other check items, the live casting server 150 determines that the reservation can be accepted.

Accordingly, in order to check the number of reserved frames by the live casting server 150, the reservation status for each content provider registered as a premium member is stored in the user database 152 at least for the previous month.

If the live reservation is accepted, in step SP16, the live casting server 150 creates the reservation ID used only for authentication when the reserved program is distributed, and writes the reserved content information including the reserved time slot, the distribution channel, the transmission band (bps), and the mail addresses of a friend list, the user ID for identifying the content provider, and the reservation ID into the reservation database 151 (FIG. 11), thereby performing the reservation registration. The process then proceeds to step SP17.

Simultaneously, if it has been set in the new program reservation screen 164 to post the content guide information in the program guide display area 160A of the live casting service top page screen 160, the live casting server 150 changes the billing flag information of the user database 152 to “billable”, thereby performing billing processing.

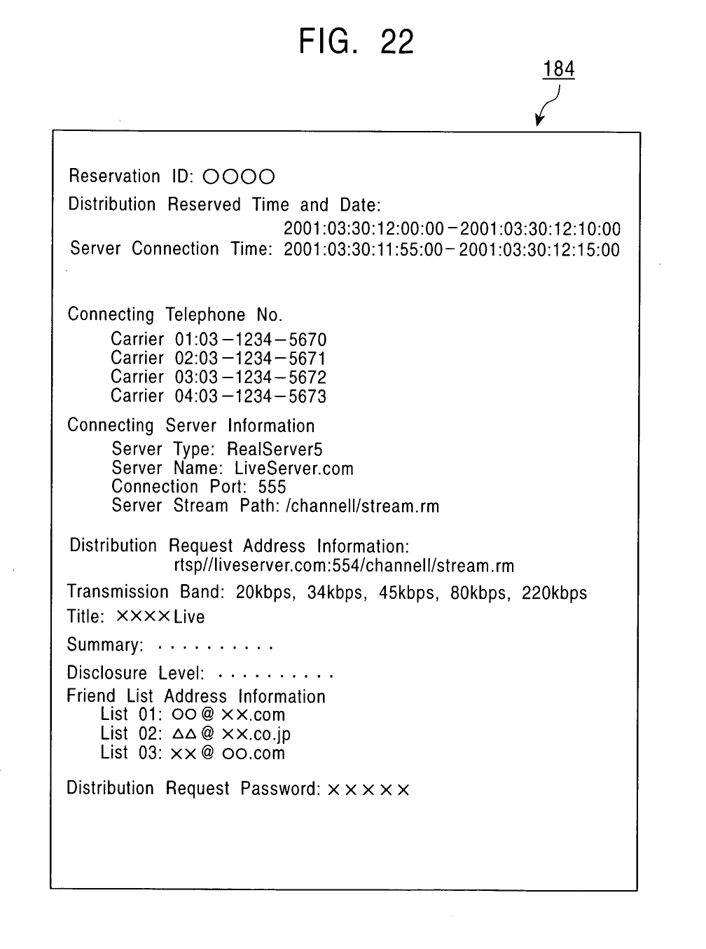

In step SP17, by referring to the reservation database 151 and the user database 152, the live casting server 150 creates a reservation setting information file 184, such as that shown in FIG. 22, having the same content as the registered reservation. The process then proceeds to step SP18.

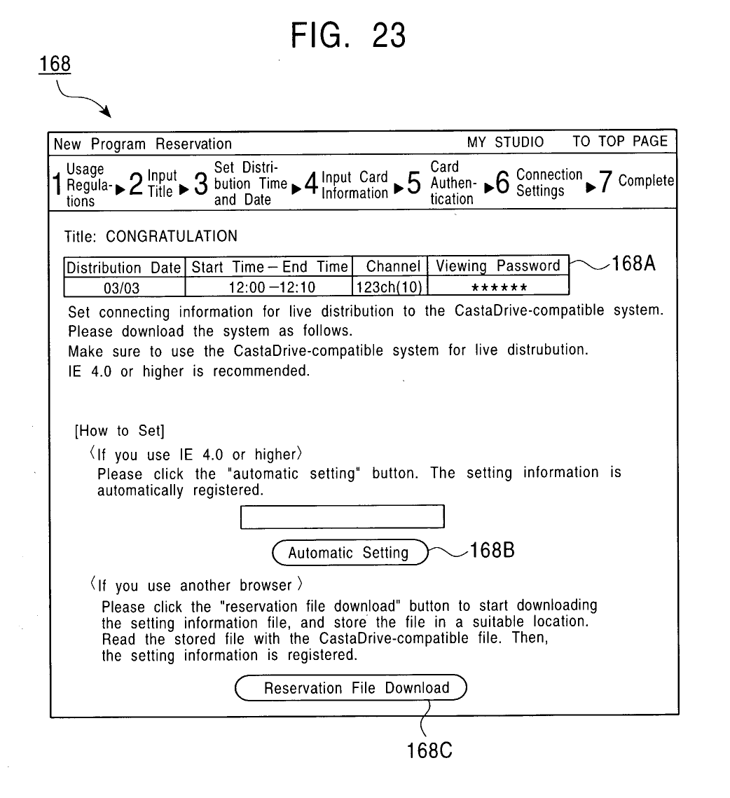

Then, the CPU 10 of the user PC 4 displays an automatic-setting screen 168, such as that shown in FIG. 23, for automatically setting the reservation setting information file, based on the subsequent web page received from the live casting server 150.

In the automatic-setting screen 168, the “distribution day”, the “start time and end time”, the “channel”, and the “viewing password”, which correspond to the “title” (“CONGRATULATION” in the example shown in FIG. 23) for checking the content of the reservation setting information file 184, are displayed in a reservation content display column 168A so that the content provider can confirm the content of the reservation setting information file 184. The password indicated in the “viewing password” is the distribution request password in the reservation setting information file 184.

When an automatic-setting button 168B is clicked after checking the reservation content display column 168A in the automatic-setting screen 168, the CPU 10 of the user PC 4 requests the live casting server 150 to send the reservation setting information file 184.

A “reservation file download” button 168C is also provided for the automatic-setting screen 168. With this button, even if the reservation setting information file 184 cannot be automatically installed by the basic program of the user PC 4, it can be formatted into a file that can be received by the user PC 4, and then, it can be downloaded by using the live casting server 150.

In step SP18, in response to the request from the user PC 4, the live casting server 150 encrypts the reservation setting information file 184 according to an encryption technique, such as the data encryption standard (DES), and sends the encrypted reservation setting information file 184 to the user PC 4. The process then proceeds to step SP19.

In step SP19, the CPU 10 of the user PC 4 receives the encrypted file from the live casting server 150, and decrypts the file by using a program, for example, “ActiveX”, so as to read the reservation setting information file 184. The CPU 10 of the user PC 4 then automatically installs the reservation setting information file 184 into a predetermined storage area of the hard disk 13 according to the commands contained in the reservation setting information file 184, and the process then proceeds to step SP20.

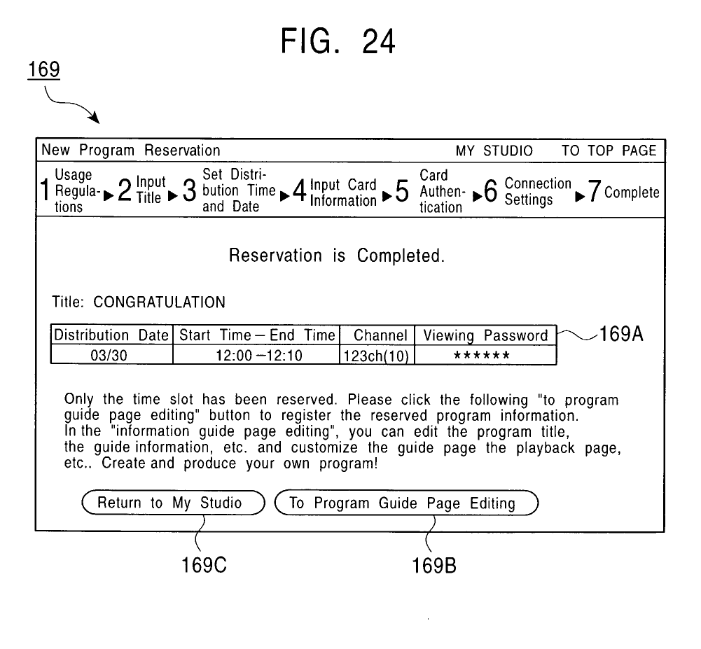

In step SP20, after completing the automatic installation of the reservation setting information file 184, the CPU 10 of the user PC 4 displays a reservation completion screen 169, such as that shown in FIG. 24.

In the reservation completion screen 169, a message, such as “your reservation is completed”, is displayed, and a reservation content report column 169A having the same information as the reservation content display column 168A of the automatic-setting screen 168 is also displayed. In this example shown in FIG. 24, the message, such as “only the time slot has been reserved”, is displayed, and the content provider is instructed to proceed to the subsequent processing, i.e., the program guide page editing processing, so as to create and produce the program.

That is, at this stage, the reservation registering processing is provisionally completed. The CPU 10 of the user PC 4 is then able to perform stream distribution via the streaming server 8 when the distribution start time is reached.

In this case, since only the time slot is reserved, the content program guide information remains blank. However, although the reservation registering processing is incomplete, it is time-saving for the content providers who do not need to post the program guide information or for the content providers who do not have enough time until live distribution after conducting reservation registering.

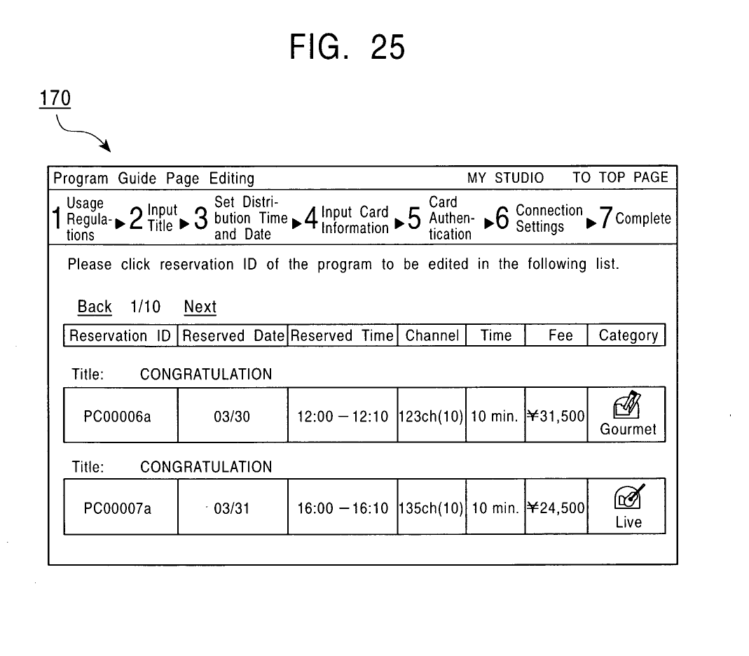

In this reservation completion screen 169, when a “to program guide page editing” button 169B is clicked, the CPU 10 of the user PC 4 receives the subsequent web page from the live casting server 150, and displays an editing selection screen 170, such as that shown in FIG. 25.

In the editing selection screen 170, a plurality of items of content reserved by the content provider are indicated, and the content provider is instructed to click the reservation ID of a desired program to be edited.

In step SP21, when the reservation ID of the program to be edited is clicked by the content provider in the editing selection screen 170, the CPU 10 of the user PC 4 sends the clicked reservation ID to the live casting server 150 via the Internet 2.

Upon receiving the reservation ID from the user PC 4, the live casting server 150 sends the web page of the program guide page editing screen corresponding to the reservation ID to the user PC 4.

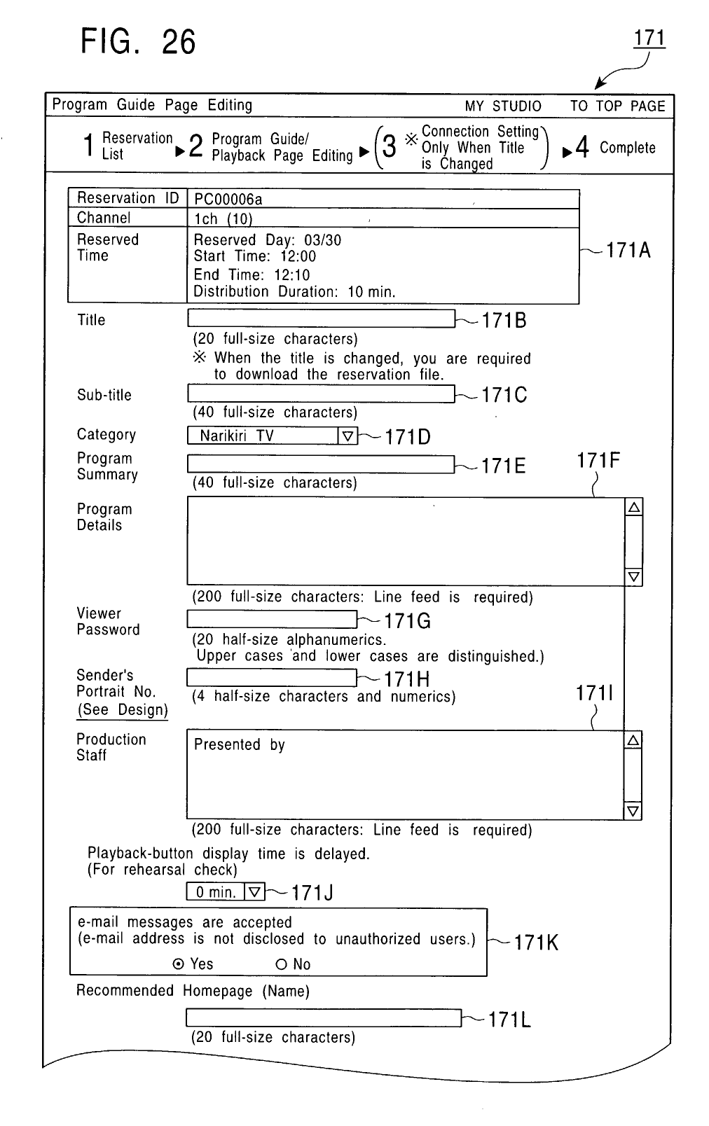

In step SP22, the CPU 10 of the user PC 4 displays a program guide page editing screen 171, such as that shown in FIGS. 26 and 27, based on the web page received from the live casting server 150, and performs editing processing on the program guide information.

In the program guide page editing screen 171, a reservation content display column 171A including “reservation ID”, “channel”, and “reserved time” is displayed at the top of the program guide page editing screen 171. A title input column 171B for inputting a program title is provided under the reservation content display column 171A.

The title input column 171B is provided for the program guide page editing screen 171 because the program title determined when the user has initially registered the reservation may be changed. If the program title is changed, a new program title is displayed, together with the “reserved time” in the reservation content display column 171A, in the program guide display area 160A of the live casting service top page screen 160.

Under the title input column 171B, a sub-title input column 171C, a category input column 171D, a program summary input column 171E, a program detail input column 171F, and a viewer password input column 171G are provided, and the content provider is instructed to input desired items according to the content to be distributed.

A portrait number setting column 171H is disposed under the viewer password input column 171G. When a “see design” button is clicked, a plurality of portrait images corresponding to portrait numbers are displayed. The sender is then able to select a portrait image as his/her portrait.

Accordingly, by selecting a desired portrait number from the plurality of portrait images and inputting it into the portrait number setting column 171H, the content provider, i.e., the sender, is able to post the selected portrait image in the program guide display area 160A of the personal casting service top page screen 160.

A production staff input column 171I is disposed under the portrait number setting column 171H, and various types of information concerning the production staff that has produced the content can be input.

A playback-button display time delaying column 171J is provided under the production staff input column 171I. If the content provider wishes to perform a rehearsal check by operating the user PC 4 and the streaming server 8 before distributing the content, the content provider inputs a delay time by which the display of the playback button on the client PCs 7A, 7B, and 7C is to be delayed into the playback-button display time delaying column 171J. In this case, the delay time is equal to the time required for performing a rehearsal check.

In this case, in the client PCs 7A, 7B, and 7C, only the distribution start time reflecting the delay time is displayed, and the images displayed during the rehearsal check are not sent to the client users.

A message-receiving setting column 171K is provided under the playback-button display time delaying column 171J. In the message-receiving setting column 171K, it can be set whether e-mail messages concerning the content from client users who view the program guide display area 160A of the personal casting service top page screen 160 are to be received. The content provider simply checks a “Yes” column or a “No” column.

If it is set that the content provider receives e-mail messages from client users, the client users who have viewed the program guide display area 160A of the personal casting service top page screen 160 are able to make a query about the information concerning the content, for example, the place of the live show, to the content provider by e-mail, and the information concerning the content can be widely sent to unspecified client users.

Under the message-receiving setting column 171K, homepage setting columns 171L and 171M are provided for inputting the name and the URL of a recommended homepage, respectively, and a pickup posting setting column 171N is also provided in which the content provider is asked whether to post the URL of the homepage in the program guide display area 160A of the personal casting service top page screen 160.

Under the pickup posting setting column 171N, a pickup introduction message setting column 171P for inputting an introduction message to be posted in the program guide display area 160A, a design setting column 171Q for selecting a design of a playback display screen and a guide page screen, a question setting column 171R for inputting a question to be asked to the client users in the playback display screen, and three answer setting columns 171S, 171T, and 171U for setting three types of answers corresponding to the question are provided.

A program guide page preview button 171V can be clicked by the content provider to view the program guide page screen as a preview. A playback page preview button 171W can be clicked by the content provider to view the playback display screen as a preview.

When an editing completion button 171X is clicked after editing the program guide page in the program guide page editing screen 171, the CPU 10 of the user PC 4 sends editing result data obtained by performing editing in the program guide page editing screen 171 to the live casting server 150 via the Internet 2, and the editing processing is then completed.

If it is desired that editing processing be performed on another program, the content provider simply clicks a “return to reservation list” button 171Y, and the CPU 10 of the user PC 4 re-displays the editing selection screen 170 (FIG. 25), and instructs the content provider to select a program to be edited.

Upon receiving the editing result data, the live casting server 150 adds the editing result data to the reservation registration content in accordance with the reservation ID so as to update the reservation registration content, and also sends the web page indicating the updating result to the user PC 4.

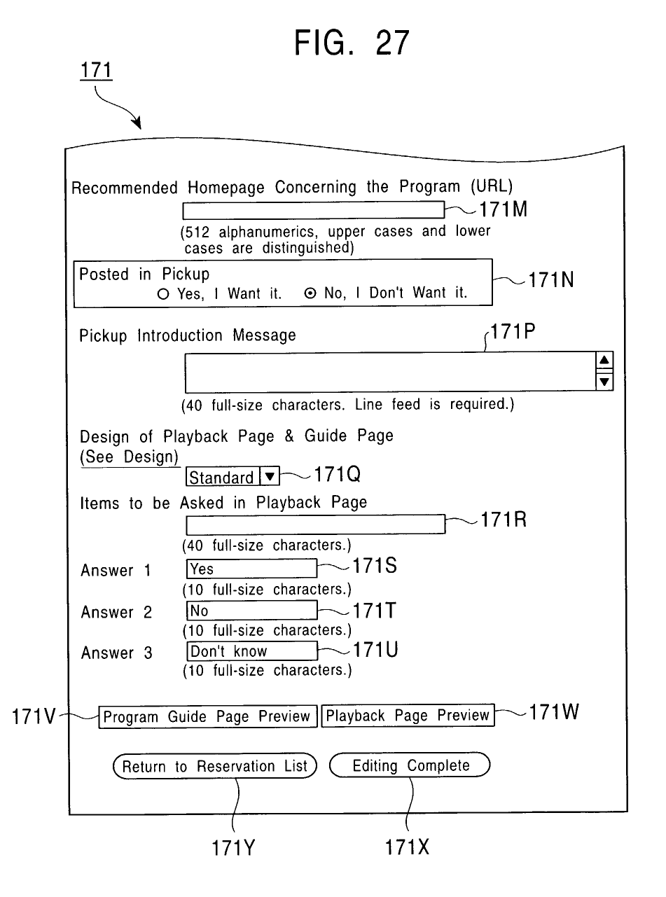

Then, the CPU 10 of the user PC 4 displays an editing update screen 172, such as that shown in FIG. 28, based on the web page received from the live casting server 150. The content provider is then informed that the editing processing for the program guide information is completed.

(2-3) Live Distribution

After completing the above-described live reservation registering, when the live distribution start time is reached, the user PC 4 connects to the streaming server 8 via a dedicated line (server-connection dedicated network 6), or via the cable television network 3B or the ADSL network 3C and the Internet 2, and starts distributing the content to the client PCs 7A, 7B, and 7C.

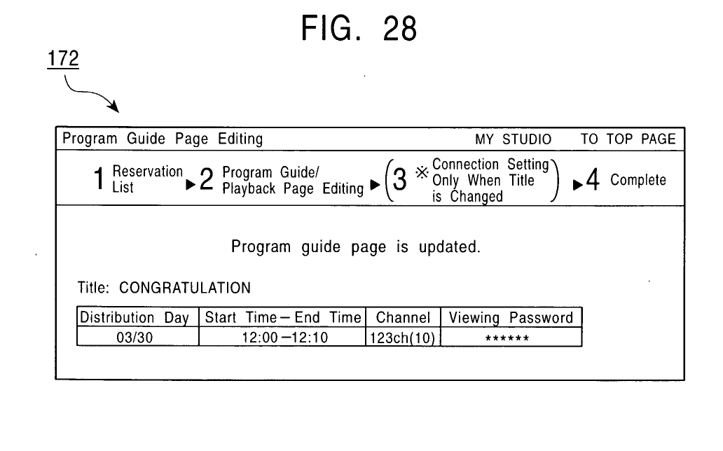

A description is now given, with reference to FIG. 29, of the content distribution sequence in the user PC 4, the streaming server 8, and the database server 155, to be taken when sending the content from the user PC 4 to the streaming server 8.

When live distribution is performed, the user PC 4 is permitted to connect to the streaming server 8 via a dedicated line or the Internet 2 five minutes before the live distribution start time. Accordingly, processing for establishing a communication connection between the user PC 4 and the streaming server 8 can be started five minutes before the distribution start time.

The content provider is thus required to prepare for the live distribution at the latest five minutes before the distribution time.

For example, before the live distribution, the content provider determines the image-capturing position of the digital video camera 19 (FIG. 2) of the user PC 4, or sets the special effect item based on the concept of the content (FIGS. 12, 13, and 14).

In this embodiment, the user PC 4 stores a live distribution announcement program in the hard disk 13, and a message, such as “live distribution will be soon started”, is displayed at a predetermined time (for example, ten minutes) before the live distribution start time, so as to inform the content provider of the start of distribution.

In step SP51, when the predetermined time is reached before the live distribution start time, the user PC 4 executes the above-described program so as to display a message, such as that “live distribution will be soon started”, on the display unit 14, thereby attracting the content provider's attention. The process then proceeds to step SP52.

In this case, if the live distribution mode has not been set by the content provider, the CPU 10 of the user PC 4 automatically selects the live distribution mode according to the corresponding application program, and displays the live distribution mode screen 54 (FIG. 10A) on the display unit 14.

In step SP52, when the start time (five minutes before the live distribution start time) at which the user PC 4 can be connected with the streaming server 8 is reached, the CPU 10 of the user PC 4 executes the predetermined connection processing program, and automatically performs the communication connection processing to be connected to the streaming server 8 via the dedicated line or the Internet 2.

In step SP53, when the start time is reached, the user PC 4 automatically starts the communication connection processing, and sends the reservation ID to the database server 155 via the Internet connection preset by the content provider so as to send an authentication request.

Accordingly, since the CPU 10 of the user PC 4 automatically performs the calling operation, the content provider does not have to input information, such as the telephone number. This is very effective when the user PC 4 is used in the state shown in FIG. 4A or 4B, in which it is very difficult for the content provider to perform the input operations. Thus, a user-friendly content creating environment can be provided to the content provider.

In step SP54, the database server 155 performs authentication processing to check whether the reservation ID received from the user PC 4 is registered in the reservation database 151 in the scheduled time slot.

If the reservation ID is registered in the reservation database 151, the database server 155 determines that the user PC 4, which is the sender of this reservation ID, belongs to an authorized content provider. If the reservation ID is not registered in the reservation database 151, the database server 155 determines that the user PC 4 does not belong to an authorized content provider.

The reason for performing authentication processing by using the reservation ID is as follows. If authentication processing is performed by using the user ID and the password possessed by a registered member of the personal casting services, the database server 155 is able to identify that the user is a legal registered member if the user ID and the password are correct. However, it cannot be verified that the registered member has a legal live reservation in the corresponding time slot. In this case, after authenticating the content provider as a registered member, the database server 155 is required to check the registration details of the live reservation and to check whether the registered member specified by the user ID has made a reservation in the corresponding time slot. As a result, the authentication processing becomes complicated.

In contrast, since the database server 155 uses the reservation ID, which is unique to the registered member, to perform authentication processing, the user ID is not required. Thus, only simple authentication processing, such as checking whether the reservation ID is registered in the reservation time slot, which is immediately after the accessed time, is required.

In step SP55, the database server 155 sends an authentication processing result to the user PC 4, and the process proceeds to step SP56.

In step SP56, after the authentication processing is successfully completed, the CPU 10 of the user PC 4 establishes a transmission channel between the user PC 4 and the streaming server 8, and the process proceeds to step SP57.

If the authentication processing result received from the database server 155 indicates that the user is not an authorized user, the CPU 10 of the user PC 4 does not connect the user PC 4 to the streaming server 8 in step SP56.

After connecting to the streaming server 8 via the Internet 2, in step SP57, the CPU 10 of the user PC 4 sends the reservation ID to the streaming server 8, as in the processing for sending the reservation ID to the database server 155 in step SP53, so as to make a distribution request, and the process then proceeds to step SP58.

In response to the distribution request from the user PC 4 in step SP58, the streaming server 8 sends the received reservation ID to the database server 155 of the server-use reservation management center 5 so as to check whether the content provider of the user PC 4 is an authenticated user. The process then proceeds to step SP59.

In step SP59, the database server 155 performs authentication processing by checking whether the received reservation ID is registered in the reservation database 151 in the corresponding time slot. The authentication processing in step SP59 is similar to the previous authentication processing in step SP54. The process then proceeds to step SP60.

In step SP60, the database server 155 returns an authentication processing result to the streaming server 8, and the process then proceeds to step SP61.

If the authentication processing result received from the database server 155 indicates that the content provider is an authorized user, in step SP61, the streaming server 8 sends a live distribution permission to the user PC 4, and also obtains information concerning the live reservation (the reserved time slot, the distribution channel, etc.) from the reservation database 151 so as to control the live distribution based on the information.

In step SP62, the content provider operates the jog dial 16B or the operation buttons 16C so as to allow the CPU 10 of the user PC 4 to perform processing in real time for adding a preset effect to the moving picture data of the content captured by the digital video camera 19, and starts distributing the content to the streaming server 8 in real time via the Internet 2.

In this case, if the number of clients does not exceed the predetermined maximum number, the streaming server 8 unconditionally performs multi-stream distribution for distributing the content to the client PCs 7A, 7B, and 7C.

When the live reservation end time is reached, the CPU 10 of the user PC 4 finishes the content distribution processing.

When starting live distribution as discussed above, the streaming server 8 sends the time information managed by the service providers acquired from the NTP server 153 and the number-of-viewer information indicating the number of client PCs 7A, 7B, and 7C that are receiving live distribution to the user PC 4.

In addition to the time information managed by the service providers and the number-of-viewer information received from the streaming server 8, the CPU 10 of the user PC 4 displays various items of information, such as the on-air information indicating that live distribution is currently being performed, the time information indicating the lapse of time after the start of distribution, the time information managed by the user PC 4, the reservation start time information, the reservation end time information, the distribution-remaining-time information, the image size information, and the transmission rate information, in the status window 103 of the live distribution mode screen 54 (FIG. 10).

The content provider is able to obtain various items of information concerning the live distribution that is currently being performed by checking the status window 103. In particular, the content provider is able to identify the precise viewer rate indicating the number of viewers receiving this live distribution. Then, the content provider can use the viewer rate as a future reference for selecting the channel for the subsequent live distribution (selecting the number of viewers).

The content distribution from the user PC 4 is completed when the live reservation end time is reached, and thus, the streaming server 8 finishes distributing the content to the clients 7A, 7B, and 7C. When the server connection end time indicated in the “server connectable end time” of the reservation setting information file 184 (FIG. 22) is reached, the communication connection with the user PC 4 is forced to be disconnected.

If the content provider operates the jog dial 16B (FIGS. 3A through 4B) before the live reservation end time so as to select the “start/end distribution” of the GUI 102 in the live distribution mode screen 54 with the focus F, the CPU 10 of the user PC 4 completes the transmission processing and disconnects the communication connection with the streaming server 8. Accordingly, the live distribution can be forced to be finished before the live distribution end time.

(2-4) Extension Processing for Reserved Time Slot During Stream Distribution

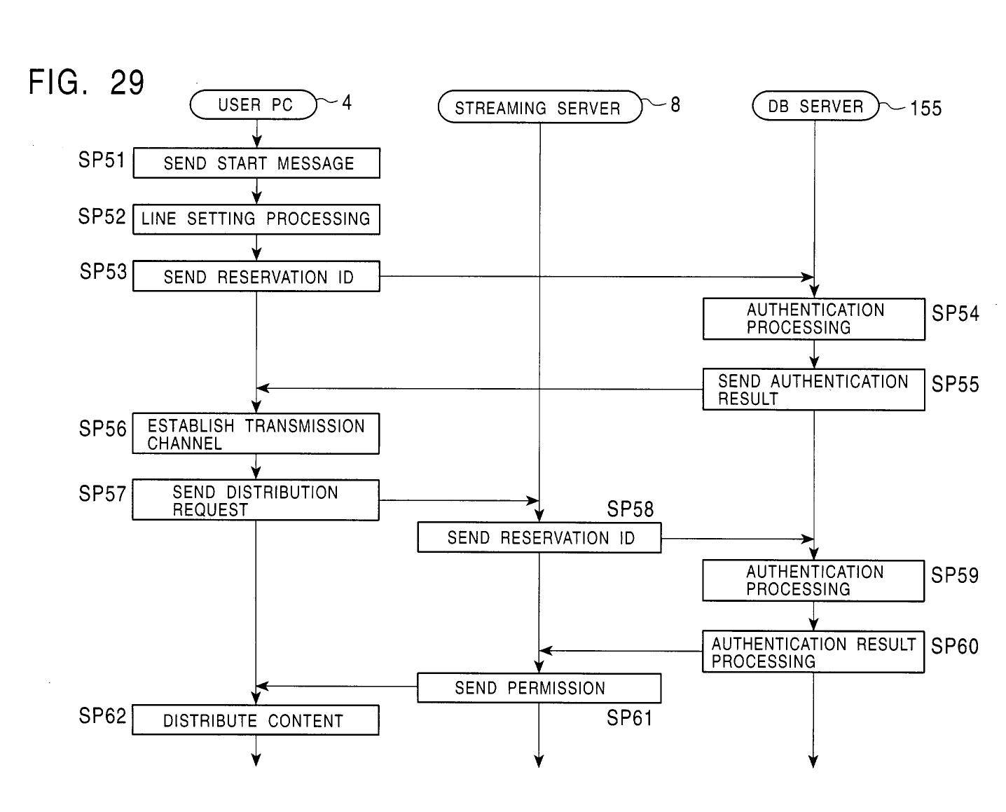

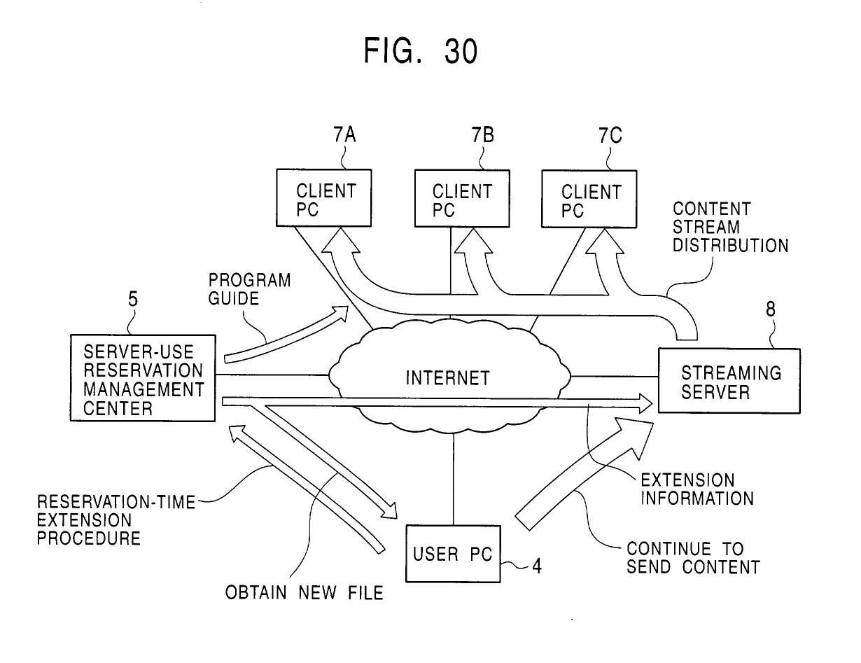

A description is now given, with reference to a reserved-time-extension processing flow in FIG. 30 and a reserved-time-extension processing sequence in FIG. 31, of a reserved-time-extension processing procedure in the live distribution mode when the extension of a reserved time slot is requested since a live broadcast is not finished within the scheduled reserved time slot while the content is being distributed via the streaming server 8 in the reservation channel in the reserved time slot.

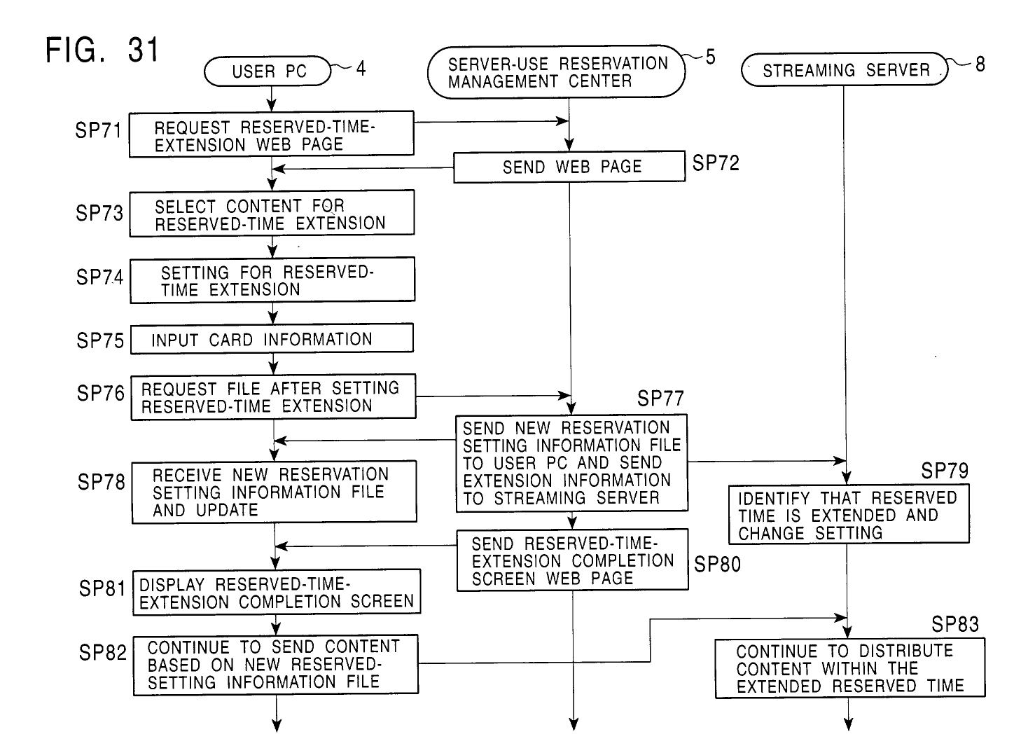

In step SP71, when clicking the sub item “to live-reserve/check” mode in the item “mode” of the GUI 102 in the live distribution mode screen 54 (FIG. 10A), the CPU 10 of the user PC 4 displays a reserved-time-extension procedure screen 175, such as that shown in FIG. 32, based on the web page received from the live casting server 150, such that the reserved-time-extension procedure screen 175 is overlaid on the “my studio” start screen 162.

In this reserved-time-extension procedure screen 175, the reserved-time-extension procedure flow is indicated by steps 1 through 6. When the first step “reservation list” is clicked, the user PC 4 requests the live casting server 150 to send a reserved-time-extension web page, and the process proceeds to step SP72.

In step SP72, the live casting server 150 of the server-use reservation management center 5 sends the reserved-time-extension web page to the use PC 4, and the process proceeds to step SP73.

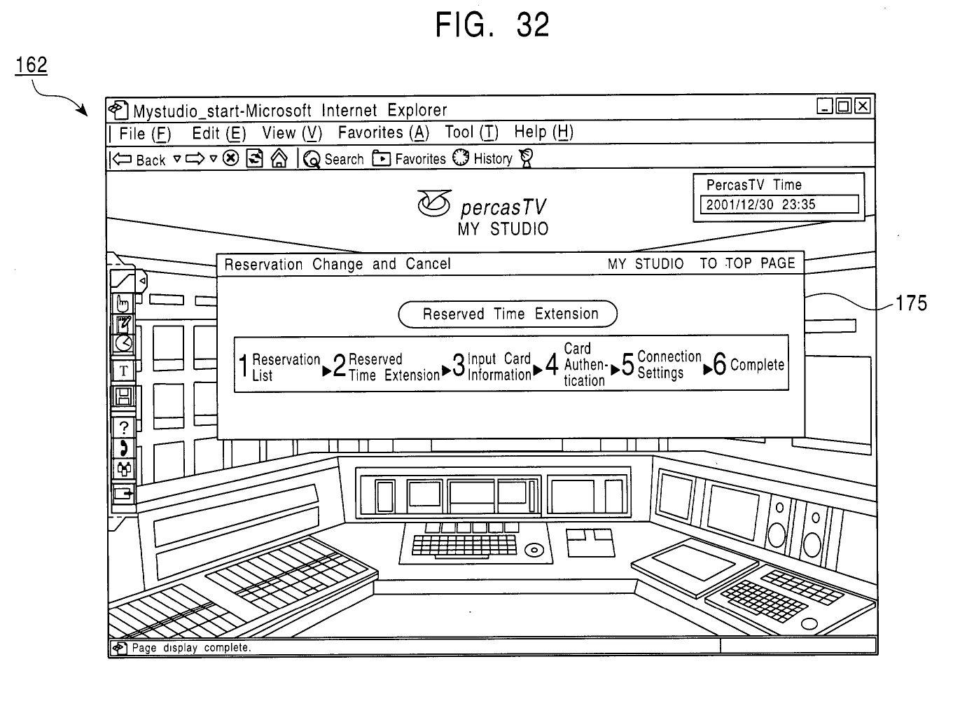

In step SP73, the CPU 10 of the user PC 4 displays a reserved-time-extension selection screen 176, such as that shown in FIG. 33, based on the web page received from the live casting server 150.

In the reserved-time-extension selection screen 176, a plurality of items reserved by the content provider are indicated, and the content provider is instructed to click the reservation ID of the title of a program whose reserved time is to be extended while the content is being distributed.

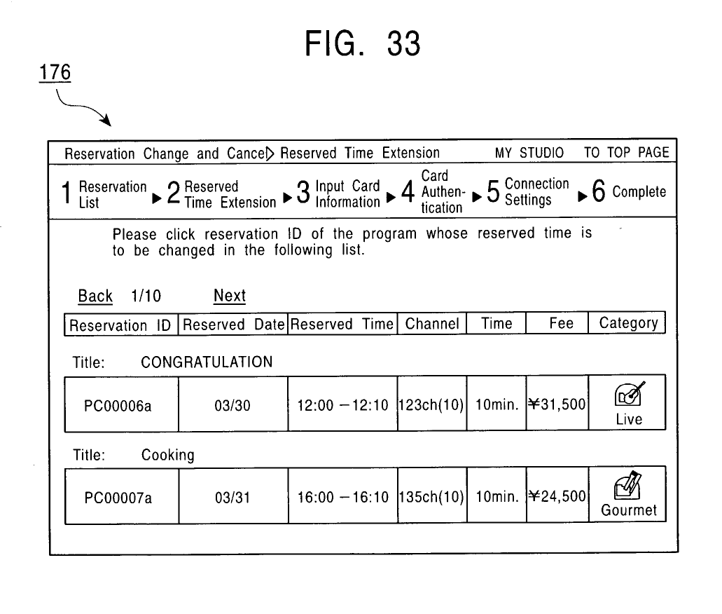

For example, if the reservation ID (PC0006a) concerning the program with the title “CONGRATULATIONS” is clicked, the CPU 10 of the user PC 4 receives the subsequent web page from the live casting server 150, and displays a reserved-time-extension setting screen 177, such as that shown in FIG. 34, based on the received web page.

In the reserved-time-extension setting screen 177, a reserved-time list 177A, a reservation content display column 177B indicating the current reservation status, and a time setting column 177C for designating a new extended distribution time are provided.

In the reserved-time list 177A, the time slots reserved in the distribution channel (123ch) are indicated in different colors in units of 10 minutes, and, in this case, a display area for ten minutes from 12:00 to 12:10 is indicated in a first color as the “my reservation”.

In the reservation content display column 177B, detailed information concerning the content program to be extended is displayed, and the content provider is able to visually check the details by referring to the reservation content display column 177B.

In the time setting column 177C, a new extended distribution time can be input in units of ten minutes.

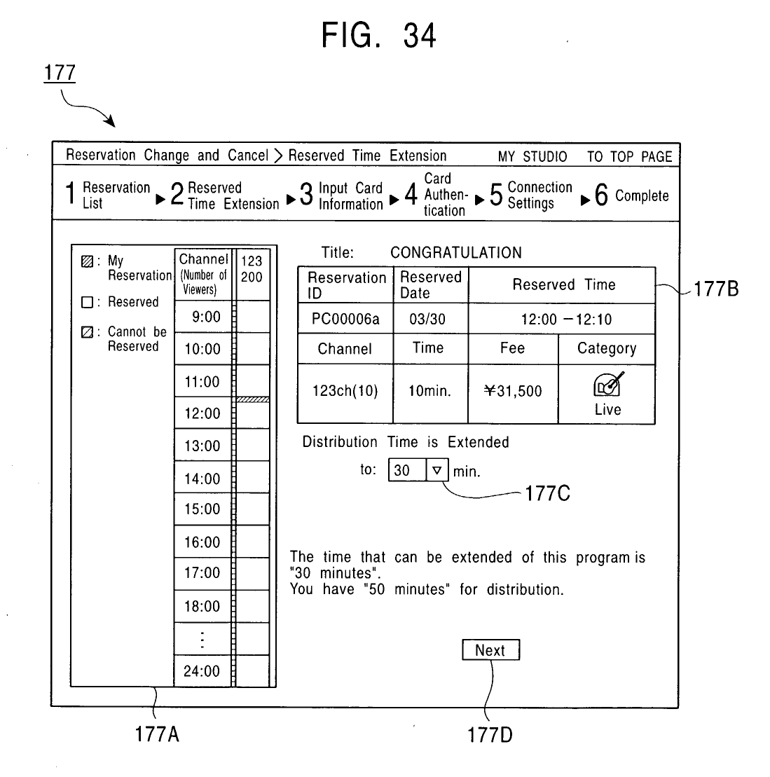

If it is desired that the distribution time be extended to, for example, 30 minutes, in the time setting column 177C, the display area in the time slot in the reserved-time list 177A is increased to 12:30, as shown in FIG. 35. Then, the content provider is able to visually identify that the extension setting of the reserved time has been made.

If the desired time slot is already reserved by another user, the CPU 10 of the user PC 4 receives a message, indicating that the reserved time slot cannot be extended, from the live casting server 150, and displays the corresponding message.

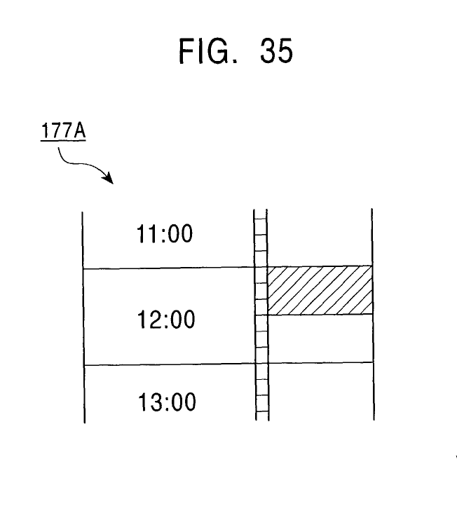

In step SP74, the extended distribution time is set by inputting “30” into the time setting column 177C by the content provider. Then, when a “next” button 177D is clicked, the CPU 10 of the user PC 4 receives the subsequent web page from the live casting server 150, and displays a card information input screen 178 concerning the extension of the reserved time slot, such as that shown in FIG. 36, based on the received web page.

In the card information input screen 178, a reservation content display column 178A, a fee display column 178B, and a card information input column 178C are provided. The content provider is instructed to input credit card information after visually checking the reservation content and the total usage fee, including the extension fee, for the content distribution.

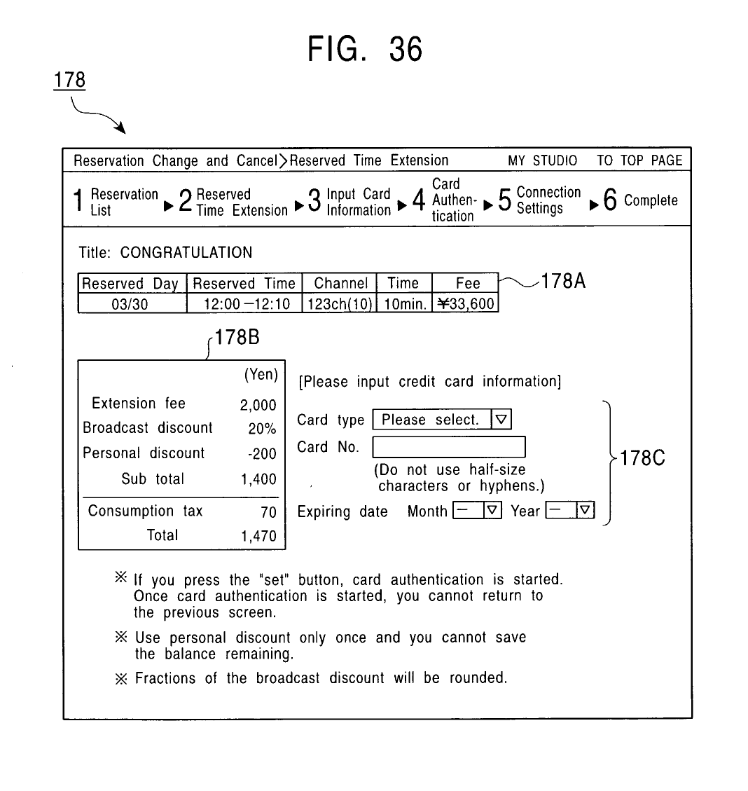

After the content provider inputs the credit card information in step SP75, the CPU 10 of the user PC 4 displays a card-information authenticating screen 179, such as that shown in FIG. 37, based on the subsequent web page received from the live casting server 150 so as to inform the content provider that the credit card information is now being authenticated.

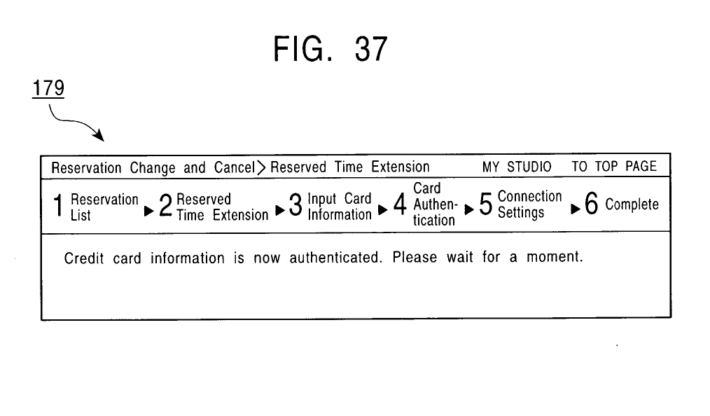

After completing the authentication of the card information by the server-use reservation management center 5, the CPU 10 of the user PC 4 displays an automatic-setting screen 180, such as that shown in FIG. 38, for automatically setting a new reservation information file after the reserved time is extended, based on the web page received from the live casting server 150.

The automatic-setting screen 180 for a new reservation setting information file is similar to the automatic-setting screen 168 (FIG. 23) for the reservation setting information file 184.

In the automatic-setting screen 180, the “distribution day”, “start time and end time”, “channel”, and “viewing password”, which correspond to the “title” (in this case, “CONGRATULATIONS”), are indicated in a reservation content display column 180A. The “start time and end time” is changed to the time slot after the reserved time is extended.

In step SP76, when an automatic-setting button 180B is clicked after the content provider checks the details in the reservation content display column 180A, the CPU 10 of the user PC 4 requests the live casting server 150 to send a new reservation setting information file, and the process proceeds to step SP77.

A “reservation file download” button 180C is also provided for the automatic-setting screen 180. With this button, even if the new reservation setting information file cannot be automatically installed by the basic program of the user PC 4, it can be formatted into a file that can be received by the user PC 4, and then, it can be downloaded by using the live casting server 150.

In step SP77, the live casting server 150 creates a new reservation setting information file and sends it to the user PC 4, and also sends extension information concerning the extended reserved time to the streaming server 8. The process then proceeds to step SP78.

In this case, the live casting server 150 changes the billing flag information of the user database 152 to “billable”, and also performs billing processing by adding the amount of fee according to the extended period of time.

In step SP78, the CPU 10 of the user PC 4 receives the new reservation setting information file from the live casting server 150, and updates it. In step SP79, the streaming server 8 identifies based on the extension information received from the live casting server 150 that the distribution time is extended, and sets the new distribution time.

Accordingly, in the content distribution system 1, information concerning the reserved time slot can be shared between the user PC 4 which sends the content to the streaming server 8 and the streaming server 8 which receives the content and distributes it. Thus, it is possible to avoid a situation in which one of the user PC 4 and the streaming server 8 does not know the extension of the reserved time.

In step SP80, after completing the extension of the reserved time, the live casting server 150 sends a reserved-time-extension completion screen web page to the user PC 4, and the process proceeds to step SP81.

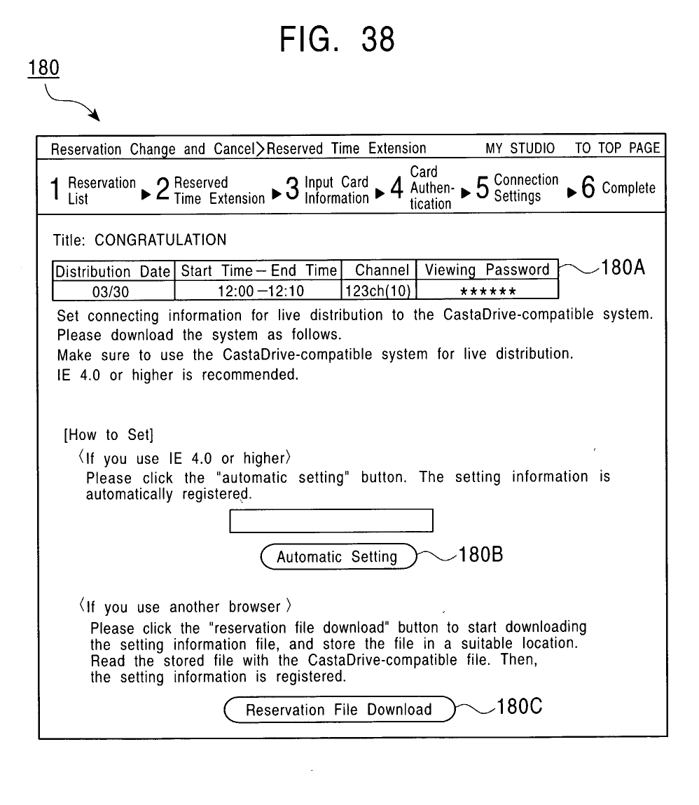

In step SP81, the CPU 10 of the user PC 4 displays a reserved-time-extension completion screen web page 181, such as that shown in FIG. 39, based on the web page received from the live casting server 150, thereby informing the content provider that the reserved time slot has been extended. The process then proceeds to step SP82.

In step SP82, the CPU 10 of the user PC 4 continues to send the content to the streaming server 8 until the extended distribution end time is reached based on the new reservation setting information file, and the process proceeds to step SP83.

In step SP83, the streaming server 8 continues to distribute the content received from the user PC 4 based on the new distribution time, and the reserved-time-extension sequence is completed.

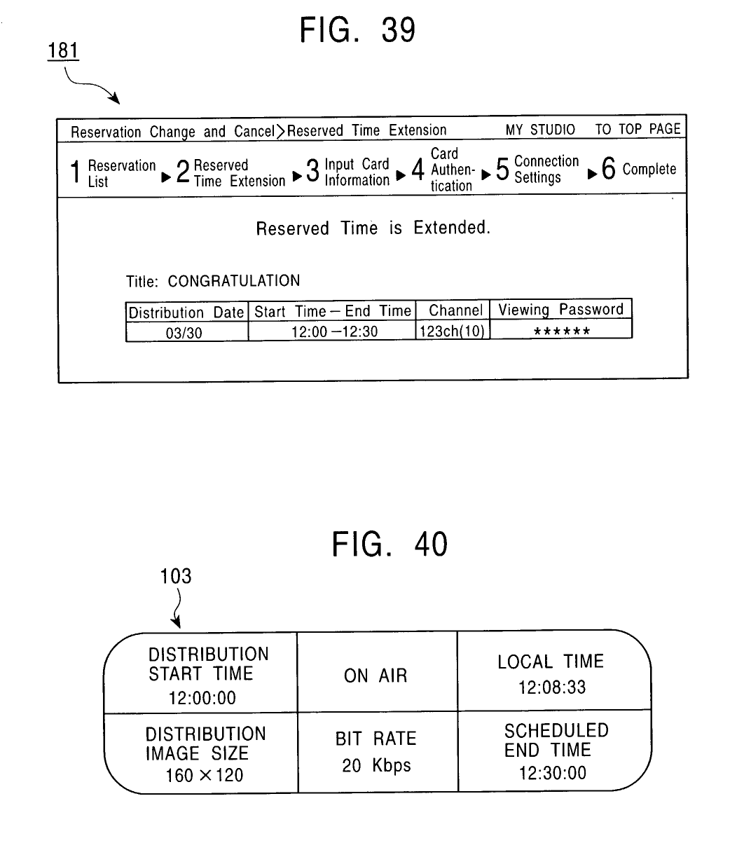

The CPU 10 of the user PC 4 continues to display the program title having the extended reserved time in the reserve list display column 106 in the live distribution mode screen 54 (FIG. 10A) until the distribution end time is reached. As shown in FIG. 40, the CPU 10 of the user PC 4 also displays in the status window 103, not only on-air information indicating that a live broadcast is currently distributed, time information of the service provider in personal casting services, the distribution start time, image size information, and bit rate information indicating the transmission rate (bit rate) of the distribution data, but also a new distribution end time after the reserved time is extended.

(2-5) Stream Distribution Processing from Streaming Server to Client PC

Subsequently, after receiving the content from the user PC 4, the streaming server 8 distributes the content to the client PC 7A, 7B, or 7C which has made a request to receive the content. The stream distribution processing is described below with reference to the display screen of the client PC 7A, 7B, or 7C.

In making a content distribution request, when power is supplied from a client user, the client PC 7A, 7B, or 7C runs browser software. Then, when a predetermined URL is input by the client user, the client PC 7A, 7B, or 7C requests the live casting server 150 to send the personal casting service top page screen 160 via the Internet 2.

The client PC 7A, 7B, or 7C then displays the personal casting service top page screen 160 (FIG. 12) received from the live casting server 150 via the Internet 2.

In the personal casting service top page screen 160, the program guide display area 160A shown when a “today's live” button 160B is clicked is set as a default. The program guide information of the content to be distributed on that day is displayed while moving in a ring-like shape as a film roll.

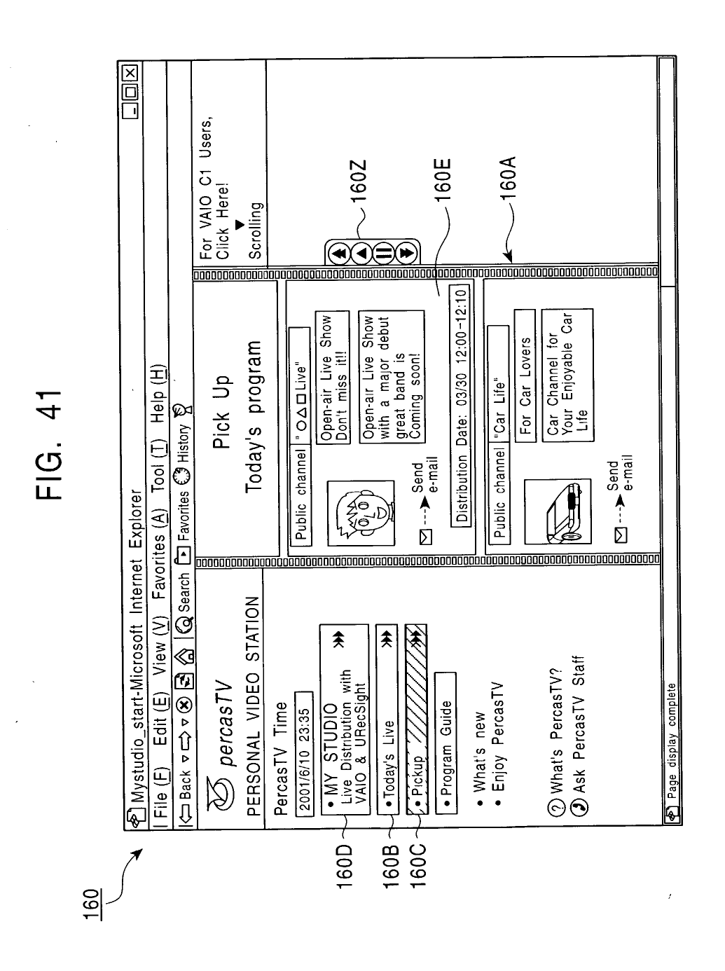

In the personal casting service top page screen 160, when the “pickup” button 160C is clicked by the client user, the CPU 10 of the user PC 4 displays the program guide information from the day one month before the scheduled day to the previous day in the program guide display area 160A, as shown in FIG. 41.

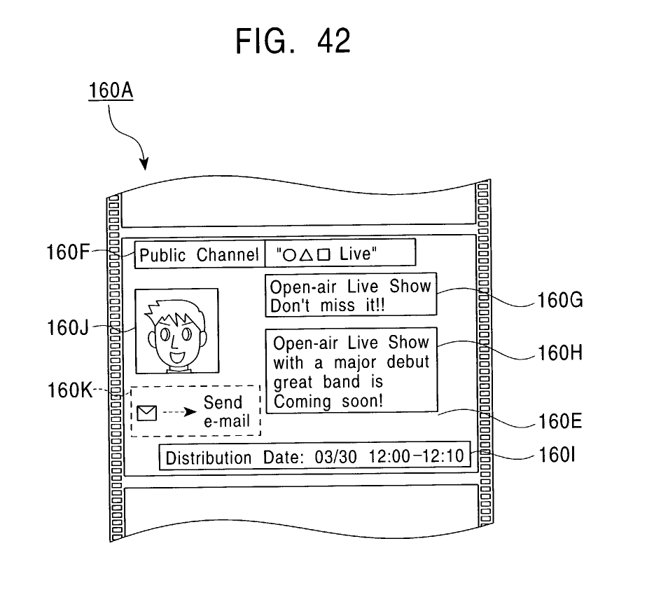

In the program guide display area 160A, as shown in FIG. 42, the program guide information of each item of content is indicated in a program guide information display portion 160E. As the program guide information, a program title is indicated in a program title display portion 160F, a sub-title of the program title is indicated in a sub-title display portion 160G, a program summary is indicated in a program summary display portion 160H, a scheduled distribution time and date is indicated in a broadcast time and date display portion 161I, a portrait image of the content provider is indicated in a portrait image display portion 160J, and an icon for sending e-mail is indicated in an e-mail icon display portion 160K.

The program title indicated in the program title display portion 160F of the program guide information display portion 160E is the program name input in the title input column 171B in the program guide page editing screen 171 (FIGS. 26 and 27). The sub-title indicated in the subtitle display portion 160G is the sub-title input in the sub-title input column 171C in the program guide page editing screen 171. The program summary indicated in the program summary display portion 160H is the summary input in the program summary input column 171E. The broadcast time and date indicated in the broadcast time and date display portion 160I is the time and date input in the reservation content display column 171A. The portrait image displayed in the portrait image display portion 160J is the portrait image corresponding to the portrait number set in the portrait number setting column 171H. The e-mail icon is displayed in the e-mail icon display portion 160K because it is set in the message-receiving setting column 171K that e-mail messages are to be accepted.

Accordingly, the live casting server 150 is able to introduce the content program in the program guide display area 160A of the personal casting service top page screen 160 (FIG. 12) as the program guide information.

Since the program guide display area 160A is displayed in the personal casting service top page screen 160, the program information can be widely informed to all the client users in the personal casting services, thereby inevitably encouraging the client users to select this program.

The client user is able to know the presence of the program in advance by checking the program guide display area 160A of the personal casting service top page screen 160. Accordingly, the client user simply clicks the “today's live” button 160B on the distribution day, and also clicks the corresponding program guide information display portion 160E in the program guide display area 160A.

Then, the live casting server 150 sends a detailed information display screen web page of the requested program to the client PC 7A, 7B, or 7C.

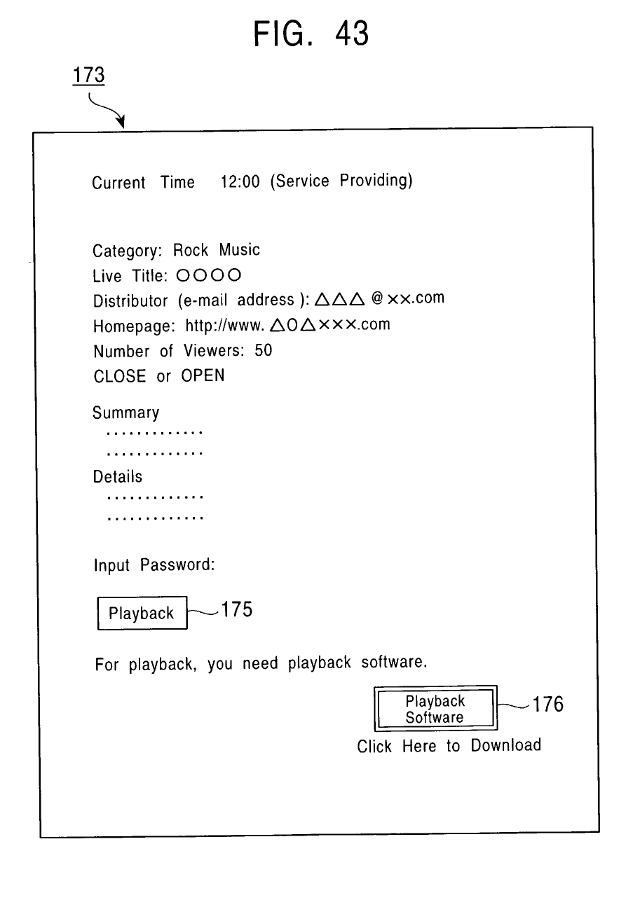

The client PC 7A, 7B, or 7C displays a program detailed information screen 173, such as that shown in FIG. 43, based on the received web page. Then, the client user is instructed to input the password for receiving the stream distribution after checking the program detailed information. When a “playback” button 175 is clicked, the password is sent to the streaming server 8.

If real-time playback software for playing back the content received from the streaming server 8 is not stored in the client PC 7A, 7B, or 7C, a “playback software” button 176 is simply clicked before clicking the “playback” button 175 so that the playback software can be downloaded.

The streaming server 8 sends the password received from the client PC 7A, 7B, or 7C to the database server 155 of the server-use reservation management center 5.

The database server 155 then performs authentication by checking whether the password received from the streaming server 8 is legal by referring to the reservation database 151, and returns an authentication result to the streaming server 8.

If the authentication result received from the database server 155 indicates that the password is legal, the streaming server 8 determines whether the live distribution is to be performed on the client PC 7A, 7B, or 7C based on the maximum number of viewers, which is preset in the distribution channel.

More specifically, the streaming server 8 compares the number of client PCs that are currently receiving live distribution with the maximum number of viewers, and if the number of client PCs is equal to the maximum number, the streaming server 8 does not perform live distribution.

In contrast, if the number of client PCs is less than the maximum number of viewers when the distribution request is made from the client PC 7A, 7B, or 7C, the streaming server 8 permits the client PC 7A, 7B, or 7C to receive live distribution, and performs stream distribution processing.

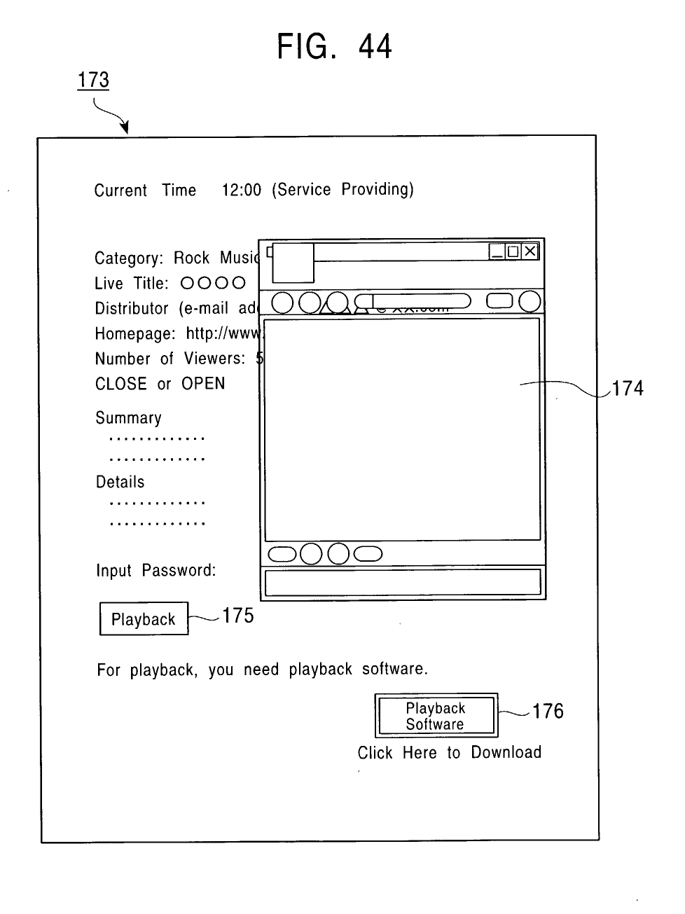

Accordingly, the client PC 7A, 7B, or 7C is able to display the content distributed from the streaming server 8 in real time in a playback display screen 174, such as that shown in FIG. 44, thereby allowing the client user to view the distributed content in real time.

In this case, the “playback” button 175 indicated in the program detailed information screen 173 is displayed in the playback display screen 174 according to the delay time set in the playback-button display time delaying column 171J in the program guide page editing screen 171.

Even if the reserved time slot has been extended by the user PC 4 and the live casting server 150 while the distributed content is being displayed in the playback display screen 174, the client PC 7A, 7B, or 7C is able to continue to receive the content from the streaming server 8 even after the distribution end time.

(3) Operation and Advantages

According to the above-described configuration, if the content provider wishes to extend the reserved time slot while the content is being distributed via the streaming server 8, the CPU 10 of the user PC 4 selects a program to be extended in the reserved-time-extension selection screen 176 (FIG. 33), sets a new extended distribution time in the reserved-time-extension setting screen 177, requests a credit card authentication in the card information input screen 178 (FIG. 36), and automatically sets a new reservation setting information file in the automatic-setting screen 180 (FIG. 38). Thus, the reserved time slot can be extended.

In this case, the live casting server 150 also sends extension information based on the new reservation setting information file to the streaming server 8, thereby informing the user PC 4 and the streaming server 8 that the scheduled end time is extended.

Accordingly, the CPU 10 of the user PC 4 is able to continue to distribute the content via the streaming server 8 until the new distribution end time is reached. Thus, even if the content provider wishes to extend the reserved time slot while the content is being distributed, the content can be continuously distributed.

In accordance with the extension of the reserved time slot, the live casting server 150 changes the billing flag information of the user database 152 to “billable”, and performs billing processing by adding the amount of fee according to the period of the extended time. Accordingly, the extension fee can be automatically collected without imposing a troublesome operation on the content provider.

According to the above-described configuration, in the content distribution system 1 in which it is normally necessary to reserve a distribution time slot in advance, if the user PC 4 sends a reserved-time-extension request to the live casting server 150 while the content is being distributed via the streaming server 8, the live casting server 150 extends the scheduled end time, and sends a new reservation setting information file to the user PC 4 and also sends extension information to the streaming server 8. This enables the user PC 4 to continue to distribute the content based on the new reservation setting information file. Thus, the content distribution can be continued without suspending the distributing operation or making a new reservation.

(4) Modifications

In the above-described embodiment, the user PC 4, which serves as a user terminal, performs the setting for extending the reserved time slot based on the web pages received from the live casting server 150, which serves as a reservation management server or a content reserved-time-extension control apparatus by using the reserved-time-extension selection screen 176, the reserved-time-extension setting screen 177, the card information input screen 178, and the automatic-setting screen 180. Alternatively, the extension setting may be made by displaying the above-described screens according to application programs stored in the user PC 4 and by directly sending the extension request data concerning the extension request to the live casting server 150.

In the above-described embodiment, the reserved time slot is extended while the content is being distributed in real time. Alternatively, the reserved time slot may be extended while the content recorded in the user PC 4 is being distributed via the streaming server 8.

In the aforementioned embodiment, various programs, such as a program for performing regular reservations, a program for restricting various operations to be performed by the user PC 4 by automatically generating the reservation setting information file 184 and sending it to the user PC 4, and a program for extending a reserved time slot, are preinstalled in the hard disk of the live casting server 150. Also, various programs for executing processing when live reservations are made and when live distribution is performed are preinstalled in the hard disk 13 of the user PC 4. Alternatively, in the present invention, the above-described application programs may be stored in a program storage medium, that is, a package medium, such as a compact disc read only memory (CD-ROM) or a digital versatile disc read only memory (DVD-ROM), and the programs can be installed into the hard disk of the live casting server 150 or the hard disk 13 of the user PC 4 by reading the programs from the program storage medium. Alternatively, the various application programs may be temporally or permanently installed in a program storage medium, such as a semiconductor memory or a magneto-optical disk, and the programs can be installed into the hard disk of the live casting server 150 or the hard disk 13 of the user PC 4 by reading the programs from the program storage medium.

The application programs may be stored in the above-described program storage media by using a cable or wireless communication medium, such as a local area network (LAN) or a digital satellite broadcast. In this case, various communication interfaces, such as a router or a modem, may be used.

In the aforementioned embodiment, the Internet 2 is used for performing the setting for extending a reserved time slot between the user PC 4 and the live casting server 150. However, another type of cable or wireless network may be used.

Moreover, in the above-described embodiment, the user PC 4 integrating the digital video camera 19 therein is used as a broadcaster terminal for performing live distribution. However, a regular PC to which a digital video camera is connected wirelessly or is connected by a cable via an IEEE-1394 interface may be employed. Alternatively, a cellular telephone to which a digital camera is connected by a cable or a cellular telephone integrating a digital camera therein may be used instead of the user PC 4.

A cellular telephone integrating a digital camera therein is described below as a modification made to the above-described embodiment.

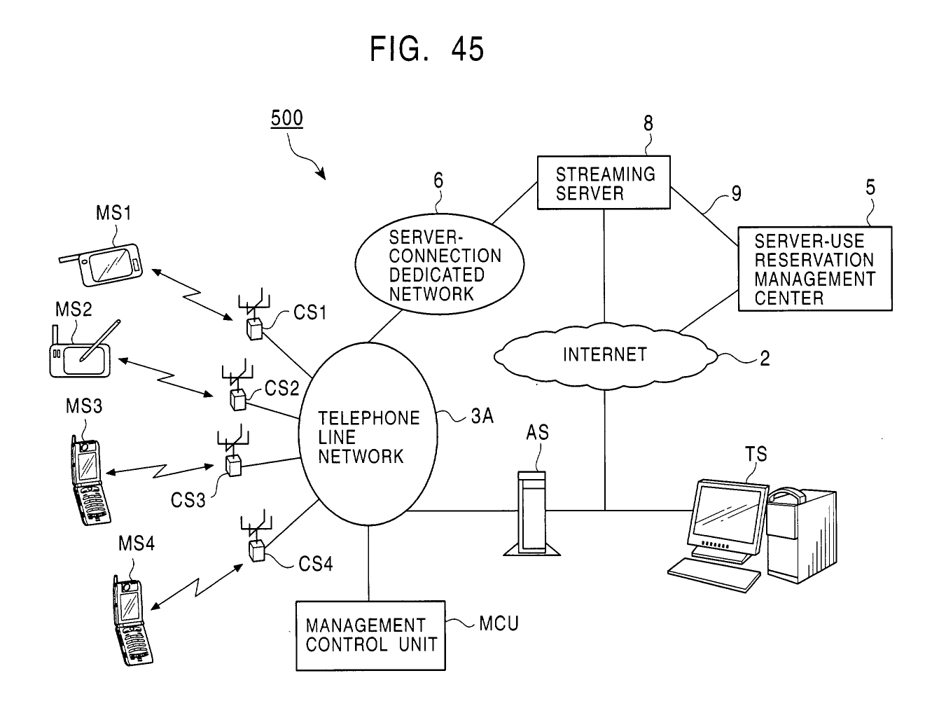

As shown in FIG. 45, a cellular telephone MS3 to which the present invention is applied is connected to a content distribution system 500. Base stations CS1 through CS4, which serve as fixed wireless stations, are disposed in corresponding cells, which are formed by dividing a communication service providing area into a desired size.

In this content distribution system 500, personal digital assistants (PDAs) MS1 and MS2, which serve as mobile wireless stations, and cellular telephones MS3 and MS4 provided with a digital camera are wirelessly connected to the base stations CS1 through CS4, respectively, according to a code division multiple access method, for example, a wideband-code division multiple access (W-CDMA) method. With this arrangement, fast data communication can be achieved in the content distribution system 500, for example, large-capacity data can be sent and received at a maximum data transfer rate of 2 Mbps by using a frequency range of 2 GHz.

In the PDAs MS1 and MS2 and the cellular telephones MS3 and MS 4, since fast data communication is implemented according to the W-CDMA method, a wide range of data communication including not only audio communication, but also the sending and receiving of e-mail, the viewing of simplified homepages, sending and receiving images, etc., can be achieved.

The base stations CS1 through CS4 are connected to the telephone line network 3A via a cable, and the Internet 2, many subscriber line terminals, computer networks, intranets, and so on (not shown), are connected to the telephone line network 3A.

An access server AV of an Internet service provider is also connected to the telephone line network 3A, and a content server TS possessed by the Internet service provider is connected to the access server AV.

In response to a request from a subscriber line terminal, the PDA MS1 or MS2, or the cellular telephone MS3 or MS4, the content server TS provides the content, such as simplified homepages, in, for example, a compact hyper text markup language (HTML) format file.

The compact HTML is a subset of the HTML, which is suitable for a limited-size display device, and corresponding tags are reserved and other portions are discarded. For example, in iMode (trade name) provided by NTT Docomo Inc. the iMode-compatible HTML is employed. In the iMode-compatible HTML, about 30 types of tags having functions only required for cellular telephones are used, and various restrictions are imposed, for example, character attributes and colors cannot be specified for text, and the two-level adjusting Graphics Interchange Format (GIF) file is recommended for images.

By using such a compact HTML, or a handheld device markup language (HDML) or a wireless markup language (WML), which is a description language used in a wireless application protocol (WAP), a simplified homepage file to be viewed by a cellular telephone, which has a limiting display area and display capacity, can be created.

As in the above-described embodiment, in the content distribution system 500, the server-use reservation management center 5 and the streaming server 8 are connected to the Internet 2 so that the subscriber line terminals, the PDAs MS1 and MS2, and the cellular telephones MS3 and MS4 can access the server-use reservation management center 5 and the streaming server 8 according to a transmission control protocol/internet protocol (TCP/IP).

As in the above-described embodiment, in the content distribution system 500, when performing streaming distribution via the streaming server 8, the content is sent from the cellular telephone MS3 or MS4 to the streaming server 8 via the server-connection dedicated network 6. However, the content may be sent via the Internet 2.

Communication is performed in the paths from the PDAs MS1 and MS2 and the cellular telephones MS3 and MS4 to the base stations CS1 through CS4 according to a simplified transport protocol at 2 Mbps, and communication is performed in the paths from the base stations CS1 through CS4 to the streaming server 8 via the Internet 2 according to the TCP/IP.

A management control unit (MCU) is connected to the subscriber line terminals, the PDAs MS1 and MS2 and the cellular telephones MS3 and MS4 via the telephone line network 3A, and performs authentication processing and billing processing for the subscriber line terminals, the PDAs MS1 and MS2 and the cellular telephones MS3 and MS4.

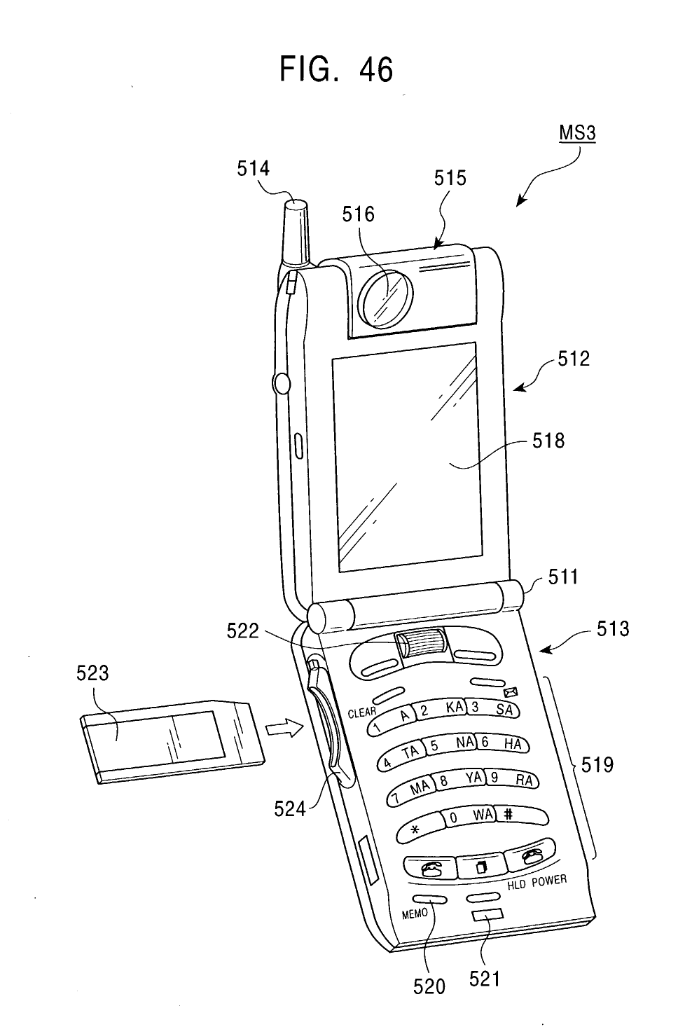

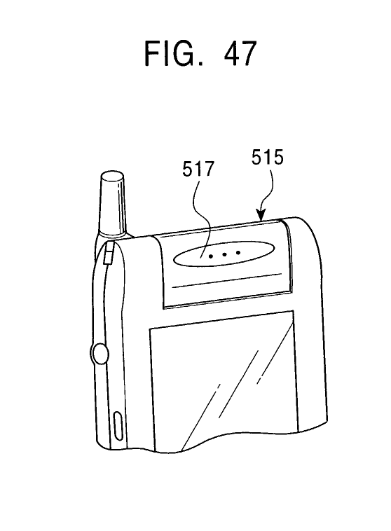

An example of the external configuration of the cellular telephone MS3, which is substituted for the user PC 4 (FIG. 1), is described below with reference to FIGS. 46 and 47.

As shown in FIG. 46, the cellular telephone MS3 is formed by connecting a display unit 512 and a main unit 513 via a hinge 511. The cellular telephone MS3 is foldable via the hinge 511.

A transmitting/receiving antenna 514 is attached to the top left portion of the display unit 512 such that it can be pulled and retracted from and into the display unit 512. The cellular telephone MS3 can transmit and receive radio waves to and from the base station CS3 via the antenna 514.

A camera portion 515 is disposed at the upper central portion of the display unit 512 such that it is rotatable about 180 degrees. A desired subject can be captured by using a charge coupled device (CCD) camera 516 of the camera portion 515.

When the camera portion 515 is rotated about 180 degrees by the content provider, a speaker 517 disposed at the back center of the camera portion 515 is positioned at the front side, as shown in FIG. 47. Then, the cellular telephone MS3 enters the regular audio communication mode.

A liquid crystal display 518 is provided at the front of the display unit 512. On the liquid crystal display 518, not only the radio reception status, the remaining amount of battery, the names and the addresses registered in the address book, and the history, but also e-mail messages, simplified homepages, images captured by the CCD camera 516 of the camera portion 515, and television programs received via a built-in antenna (not shown) are displayed.

The main unit 513 is provided with operation keys 519, such as numeric keys from “0” to “9”, a calling key, a redial key, a hang-up/power key, a clear key, and an e-mail key, and various instructions can be input by using the operation keys 519.

The main unit 513 is also provided with a memo button 520 and a microphone 521 below the operation keys 519. User voice can be recorded while talking by pressing the memo button 520, and user voice can be collected by the microphone 521.

A rotatable and pressable jog dial 522 is provided above the operation keys 519 of the main unit 513 such that it is slightly projected from the surface of the main unit 513. According to the rotation of the jog dial 522, the telephone list or an e-mail message displayed on the liquid crystal display 518 can be scrolled, a simplified homepage is scrolled, and an image can be sent.

For example, in the main unit 513, a desired telephone number is selected from a plurality of telephone numbers displayed on the liquid crystal display 518 according to the rotating operation performed on the jog dial 522 by the content provider. When the jog dial 522 is pressed toward the inward of the main unit 513, the selected telephone number is set, and the telephone number is automatically called.

A battery pack (not shown) is attached to the rear side of the main unit 513, and when the hang-up/power key is turned on, power is supplied from the battery pack to the individual circuits, and the cellular telephone MS3 becomes operable.

A memory stick slot 524 into and from which a memory stick (trade name of Sony Corporation) 523 can be inserted and removed is provided at the top left side of the main unit 513. By pressing the memory button 520, the user is able to record the voice of another person while talking to him/her, TV program video data which is currently being received, or e-mail, simplified homepages, and images captured by the CCD camera 516 can be recorded into the memory stick 523 according to the operation of the content provider.

The memory stick 523 is one type of flash memory card developed by Sony Corporation, which is the assignee to the present application. In the memory stick 523, a flash memory device, which is one type of electrically erasable and programmable read only memory (EEPROM), which is a nonvolatile memory, is stored in a small and thin plastic casing having a length of 50 mm, a width of 21.5 mm, and a thickness of 8 mm. Various types of data, such as images, voice, and music, can be read and written from and into the memory stick 523 via ten pin terminals.

In the memory stick 523, a unique serial protocol is used for ensuring the compatibility between the machines in case of a change in the specifications of the built-in flash memory for increasing the capacity. High-speed performance having a maximum writing speed of 1.5 MB/S and a maximum reading speed of 2.45 MB/S can be implemented, and high reliability can be ensured by providing a switch for preventing data from being erroneously erased.

Accordingly, by the provision of the memory stick 523 for the cellular telephone MS3, the cellular telephone MS3 is able to share the same data with other electronic devices via the memory stick 523.

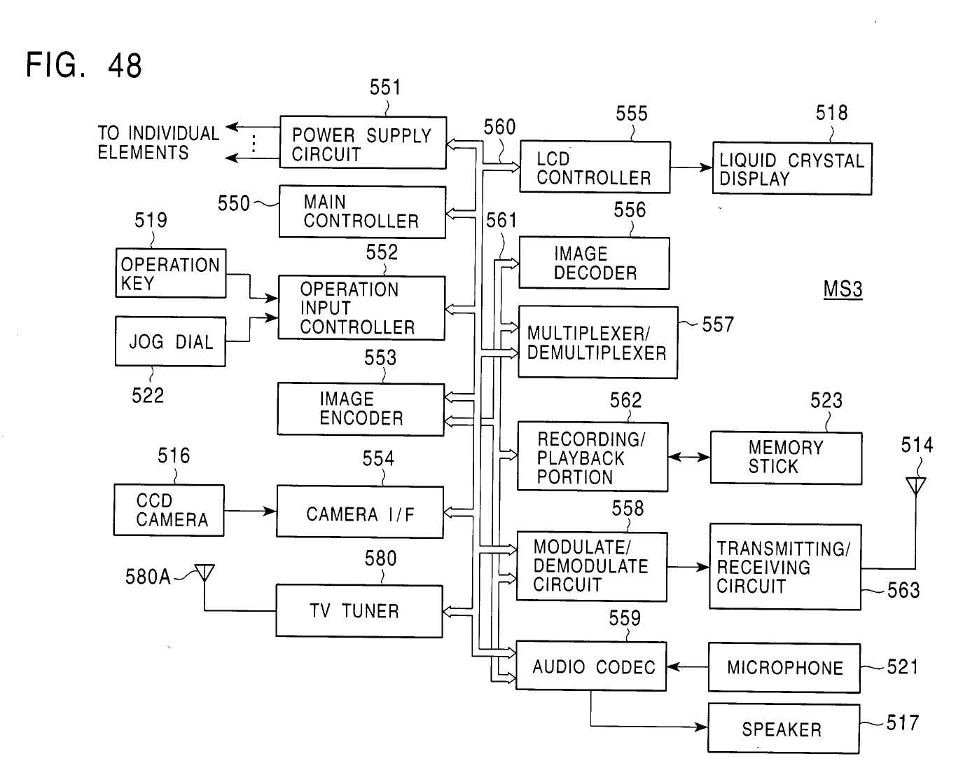

FIG. 48 illustrates the circuit configuration of the cellular telephone MS3. In the cellular telephone MS3, as shown in FIG. 48, a power supply circuit 551, an operation input controller 552, an image encoder 553, a camera interface 554, a liquid crystal display (LCD) controller 555, an image decoder 556, a multiplexer/demultiplexer 557, a recording/playback portion 562, and a modulate/demodulate circuit 558, an audio codec 559 are connected via a main bus 560 to a main controller 550 which centrally controls the individual elements of the display unit 512 and the main unit 513. The image encoder 553, the image decoder 556, the multiplexer/demultiplexer 557, the modulate/demodulate circuit 558, and the audio codec 559 are connected to each other via a synchronizing bus 561.

When the hang-up/power key is turned on by the content provider, the power supply circuit 551 supplies power to the individual elements from the battery back, so that the cellular telephone MS 3 becomes operable.

In the cellular telephone MS3, under the control of the main controller 550 formed of a CPU, a ROM, a RAM, etc., an audio signal collected from the microphone 521 in the audio communication mode is converted into digital audio data by the audio codec 559. The digital audio data then undergoes spread spectrum processing in the modulate/demodulate circuit 558, and further undergoes digital-to-analog (D/A) conversion and frequency conversion processing in a transmitting/receiving circuit 563. The digital audio data is then transmitted via the antenna 514.

In the cellular telephone MS3, a signal received via the antenna 514 in the audio communication mode is amplified and undergoes frequency conversion and analog-to-digital (A/D) conversion processing. The digital data then undergoes de-spread spectrum processing in the modulate/demodulate circuit 558, and is converted into an analog audio signal in the audio codec 559. The analog audio signal is then output via the speaker 517.

In the cellular telephone MS3, when sending e-mail in the data communication mode, e-mail text data input by the operation of the operation keys 519 or the jog dial 522 is sent to the main controller 550 via the operation input controller 552.

The main controller 550 then controls the modulate/demodulate circuit 558 to perform spread spectrum processing on the text data, and controls the transmitting/receiving circuit 563 to perform D/A conversion and frequency conversion processing on the text data. The text data is then transmitted to the base station CS3 (FIG. 45) via the antenna 514.

When receiving e-mail in the data communication mode, a signal received from the base station CS3 via the antenna 514 undergoes de-spread spectrum processing in the modulate/demodulate circuit 558 so as to be reproduced into the original text data. The text data is then displayed on the liquid crystal display 518 as an e-mail message via the LCD controller 555.

Then, in the cellular telephone MS3, the received email may be recorded in the memory stick 523 via the recording/playback portion 562 according to the operation of the content provider.

When sending image data in the data communication mode, image data captured by the CCD camera 516 is supplied to the image encoder 553 via the camera interface 554.

When the image data captured by the CCD camera 516 is not transmitted, it can be directly displayed on the liquid crystal display 518 via the camera interface 554 and the LCD controller 555.

The image encoder 553 compresses the image data supplied from the CCD camera 516 according to a predetermined coding method, such as MPEG2 or MPEG4 so as to convert the image data to encoded image data, and supplies it to the multiplexer/demultiplexer 557.

Meanwhile, the sound collected by the microphone 521 while the image is being captured by the CCD camera 516 is sent to the multiplexer/demultiplexer 557 via the audio codec 559 as digital audio data.

The multiplexer/demultiplexer 557 multiplexes the encoded image data supplied from the image encoder 553 with the audio data supplied from the audio codec 559 according to a predetermined method. The modulate/demodulate circuit 558 then performs spread spectrum processing on the resulting multiplexed data, and the transmitting/receiving circuit 563 performs D/A conversion and frequency conversion on the data. The data is then sent via the antenna 514.

When receiving data of a moving picture .file linked to, for example, a simplified homepage, in the data communication mode, the modulate/demodulate circuit 558 performs spread spectrum processing on a signal received from the base station CS3 via the antenna 514, and supplies the resulting multiplexed data to the multiplexer/demultiplexer 557.

The multiplexer/demultiplexer 557 demultiplexes the multiplexed data into the encoded image data and the audio data. The multiplexer/demultiplexer 557 then supplies the encoded image data to the image decoder 556 and the audio data to the audio codec 559 via the synchronizing bus 561.

The image decoder 556 decodes the encoded image data according to a decoding method corresponding to the predetermined encoding method, such as MPEG2 or MPEG4, so as to generate a reproduced moving picture data, and supplies the data to the liquid crystal display 518 via the LCD controller 555. Then, the moving picture data contained in the moving picture file linked to, for example, a simplified homepage, can be displayed.

Meanwhile, the audio codec 559 converts the audio data into an analog audio signal, and supplies it to the speaker 517. Then, the audio data contained in the moving picture file linked to, for example, a simplified homepage, can be played back.

In this case, as in e-mail, the received data linked to, for example, a simplified homepage, may be recorded in the memory stick 523 via the recording/playback portion 563 according to the operation of the user.

Additionally, in the cellular telephone MS3, various application programs similar to those in the above-described embodiment are stored in the ROM of the main controller 550. Based on these application programs, the cellular telephone MS3 is able to access the live casting server 150 of the server-use reservation management center 5 (FIG. 11) so as to perform the above-described membership registration, live reservation registration, the setting for extending a time slot while stream distribution is being performed, etc., with the live casting server 150.

Thus, as in the user PC 4, by performing the reserved-time-extension processing sequence shown in FIGS. 30 and 31, the cellular telephone MS3 is able to perform the setting for extending a reserved time slot while stream distribution is being performed by the streaming server 8, and continue to perform stream distribution until an extended scheduled end time is reached without suspending the distribution.

In the foregoing embodiment, the personal content is distributed from the user PC 4 via the streaming server 8 as a personal broadcast. However, the present invention is not restricted to personal broadcasting, and the content may be distributed as a commercial Internet broadcast.

In the aforementioned embodiment, the server-use reservation management center 5, which serves as the content reserved-time-extension control apparatus, is formed of the network interface 154, which serves as extension request receiving means for receiving a time-slot extension request sent from the user PC 4 while the content is being distributed from the user PC 4 to the client PCs 7A, 7B, and 7C via the streaming server 8 in the reserved distribution channel within the scheduled time slot, and the live casting server 150, which serves as reservation setting information generating means for generating a new reservation setting information file in which the time slot is extended in response to the extension request, and also serves as control means for allowing the user PC 4 to continue to send the content to the streaming server 8 based on the new reservation setting information file by sending the new reservation setting information file to the user PC 4 and also sending the extension information to the streaming server 8, and also for allowing the streaming server 8 to continue to distribute the content. However, the content reserved-time-extension control apparatus may be formed of other types of extension request receiving means, reservation setting information generating means, and control means.

What is claimed is:

1. A content distribution system comprising:
a user terminal;
a content distribution server for distributing content received from said user terminal to a client via a network; and
a reservation management server for receiving a reservation for a distribution channel and a time slot in which the distribution channel is to be used from said user terminal, wherein:
said user terminal makes an extension request for extending the time slot while the content is being distributed to the client via said content distribution server in the distribution channel and in the time slot; and
said reservation management server sends new reservation setting information in which the time slot is extended in response to the extension request to said user terminal and to said content distribution server, thereby allowing said user terminal to continue to send the content to said content distribution server based on the new reservation setting information, and also allowing said content distribution server to continue to distribute the content.

2. A content distribution system according to claim 1, wherein said reservation management server sets an extension time in response to the extension request, and performs billing processing in accordance with the extension time.

3. A content reserved-time-extension control apparatus for receiving a reservation for a distribution channel and a time slot in which the distribution channel is to be used from a user terminal when content received from the user terminal is distributed from a content distribution server to a client via a network, and for managing the received reservation, said content reserved-time-extension control apparatus comprising:
extension request receiving means for receiving an extension request for extending the time slot while the content is being distributed from the user terminal to the client via the content distribution server in the distribution channel and in the time slot;
reservation setting information generating means for generating new reservation setting information in which the time slot is extended in response to the extension request; and
control means for sending the new reservation setting information to the user terminal and to the content distribution server so as to allow the user terminal to continue to send the content to the content distribution server based on the new reservation setting information, and to allow the content distribution server to continue to distribute the content.

4. A content reserved-time-extension control apparatus according to claim 3, wherein said reservation setting information generating means sets an extension time in response to the extension request, and performs billing processing in accordance with the extension time.

5. A content reserved-time-extension control method for receiving a reservation for a distribution channel and a time slot in which the distribution channel is to be used from a user terminal when content received from the user terminal is distributed from a content distribution server to a client via a network, and for managing the received reservation, said content reserved-time-extension control method comprising:
an extension request receiving step of receiving an extension request for extending the time slot while the content is being distributed from the user terminal to the client via the content distribution server in the distribution channel and in the time slot;
a reservation setting information generating step of generating new reservation setting information in which the time slot is extended in response to the extension request; and
a control step of sending the new reservation setting information to the user terminal and to the content distribution server so as to allow the user terminal to continue to send the content to the content distribution server based on the new reservation setting information, and to allow the content distribution server to continue to distribute the content.

6. A content reserved-time-extension control method according to claim 5, wherein, in said reservation setting information generating step, an extension time is set in response to the extension request, and billing processing is performed in accordance with the extension time.

7. A content reserved-time-extension control program for allowing a computer to execute:
an extension request receiving step of, in a distribution channel and a time slot in which the distribution channel is to be used reserved for distributing content received from a user terminal from a content distribution server to a client via a network, receiving an extension request for extending the time slot from the user terminal while the content is being distributed to the client;
a reservation setting information generating step of generating new reservation setting information in which the time slot is extended in response to the extension request; and
a control step of sending the new reservation setting information to the user terminal and to the content distribution server so as to allow the user terminal to continue to send the content to the content distribution server based on the new reservation setting information, and to allow the content distribution server to continue to distribute the content.

8. A content reserved-time-extension control program according to claim 7, wherein, in said reservation setting information generating step, an extension time is set in response to the extension request, and billing processing is performed in accordance with the extension time.

9. A storage medium for storing a content reserved-time-extension control program to be executed by an information processing apparatus, said content reserve-time-extension control program comprising:
an extension request receiving step of, in a distribution channel and a time slot in which the distribution channel is to be used reserved for distributing content received from a user terminal from a content distribution server to a client via a network, receiving an extension request for extending the time slot from the user terminal while the content is being distributed to the client;
a reservation setting information generating step of generating new reservation setting information in which the time slot is extended in response to the extension request; and
a control step of sending the new reservation setting information to the user terminal and to the content distribution server so as to allow the user terminal to continue to send the content to the content distribution server based on the new reservation setting information, and to allow the content distribution server to continue to distribute the content.

10. A storage medium according to claim 9, wherein, in said reservation setting information generating step, an extension time is set in response to the extension request, and billing processing is performed in accordance with the extension time.
